(19) United States
(12) Patent Application Publication
(10) Pub. No.: US 2013/0041520 A1
(43) Pub. Date: Feb. 14, 2013

(54) METHOD AND SYSTEM FOR FACILITATING DESIGN OF A HIGH VOLTAGE (HVDC) CONTROL SYSTEM, AN HVDC SYSTEM AND A METHOD FOR OPTIMISING AN HVDC SYSTEM

(71) Applicant: Leon Chetty, Durban (ZA)

(72) Inventor: Leon Chetty, Durban (ZA)

(73) Assignee: UNIVERSITY OF KWAZULU-NATAL, Westville (ZA)

(21) Appl. No.: 13/577,436

(22) PCT Filed: Feb. 4, 2011
(86) PCT No.: PCT/IB2011/050485

§ 371 Date: Oct. 26, 2012

(30) Foreign Application Priority Data
Feb. 4, 2010 (ZA) 2010/00830

(51) Int. Cl. G05B 13/02; G06F 1/26

(52) U.S. Cl. 700/297

(57) ABSTRACT

THIS invention relates to a method of and a system for facilitating design of a classic High Voltage Direct Current (HVDC) control system, a method for optimising a classic High Voltage Direct Current (HVDC) control system, and a HVDC control system. In particular, the invention comprises the steps of determining at least a current control plant transfer function for a rectifier and/or inverter of the classic HVDC control system by using a time domain current equation; determining at least a voltage control plant transfer function for at least a rectifier of the classic HVDC control system by using a time domain voltage equation; using the determined current control plant transfer function for the rectifier and/or inverter, and/or the determined voltage control plant transfer function for at least the rectifier to facilitate design of the HVDC control system.

### BACKGROUND OF THE INVENTION

THIS invention relates to a method of and a system for facilitating design of a classic High Voltage Direct Current (HVDC) control system, a method for optimising a classic High Voltage Direct Current (HVDC) control system, and a HVDC control system.

HVDC control systems are usually designed by methods and systems which utilize, for example, a state-variable approach to define the linear and non-linear differential equations of a classic HVDC control system. This approach typically requires accurate knowledge of Alternating Current (AC) systems and correspondingly Direct Current (DC) systems and undesirably involves complicated mathematics as well computationally intensive calculations in order to achieve an end result.

In practice, it is extremely difficult, if not impossible, to obtain accurate knowledge of the AC systems connected to classic HVDC control systems. In this regard, limited time constraints imposed on HVDC control practitioners, the AC system uncertainties, and the complicated mathematics have prevented the widespread practical use of the state-variable approach to derive the plant transfer functions of classic HVDC control systems.

Trial and error methods employed to design HVDC control systems require expert knowledge of which there is a shortage of. Also, these trial and error techniques are undesirably labour intensive and not necessarily robust.

In this regard, the present invention seeks at least to address the abovementioned problems and to provide a faster, more convenient way in HVDC control systems can be designed.

### SUMMARY OF THE INVENTION

According to a first aspect of the invention, there is provided a method of facilitating design of a classic High Voltage Direct Current (HVDC) control system, the method comprising:
determining at least a current control plant transfer function for a rectifier and/or inverter of the classic HVDC control system by using a time domain current equation;
determining at least a voltage control plant transfer function for at least a rectifier of the classic HVDC control system by using a time domain voltage equation;
using the determined current control plant transfer function for the rectifier and/or inverter, and/or the determined voltage control plant transfer function for the rectifier and/or inverter to facilitate design of the HVDC control system.

The time domain current equation may be a first time domain current equation:

$${I}_{dr} ( t ) = \{ \begin{matrix}1.1 . m . ( Δ {I}_{d} - {I}_{d 1} ) . ( 1 - {e}^{- bt} ) & 0 < t < {T}_{o} \\ 1.1 m . ( Δ {I}_{d} - {I}_{d 1} ) ( 1 - {e}^{- b . t} ) + {I}_{d 1} . ( n - p . k . {e}^{- a .1} + c . k . {e}^{- a . t} . ( sin ( wt ) - m . cos ( wt ) ) & t \geq {T}_{o}\end{matrix} ,$$

wherein:
   I_{d1} may be a first peak of an oscillating component of a dc current associated with the HVDC control system;
   ΔI_{d} may be a final value of the dc current from a nominalised zero reference;

$$a = \frac{r}{{T}_{1}} ,$$

wherein:
   T₁ may be a time associated with a first peak of the dc current; and
   r may be a constant;

$$w = \frac{2 π}{{T}_{2}} ,$$

wherein:
T₂ may be a first period of the oscillating component of the dc current;
k may be a constant;
T_{∞} may be a time which the HVDC control system takes to reach a final value;

$$b = \frac{log ( \frac{1}{11} ) - log ( 1 - \frac{10. {I}_{d 1} ( 1 - {e}^{- 1} )}{11. Δ {I}_{d}} )}{- {T}_{∞}} ;$$

and
Tₒ may be a time delay selected at least to avoid formation of very high order models.

In one possible example embodiment, for a rectifier effective short circuit ratio greater than approximately 2.6:

$$m = 0 ; n = \frac{Δ {I}_{d}}{{I}_{d 1}} ; p = \frac{Δ {I}_{d}}{k . {I}_{d 1}} ; 0 < r < 1 ; and c = \frac{Δ {I}_{d}^{2}}{{I}_{d 1}} .$$

However, for a rectifier effective short circuit ratio less than approximately 2.6: m=1: n=1; r=1; q=1; and c=1.

The time domain current equation may be a second time domain current equation:

$$Δ {I}_{d} ( t ) = \{ \begin{matrix}0 & t < {T}_{d} \\ Δ {I}_{d} ( 1 - {e}^{- at} + k \vert Δ {I}_{d} \vert . {e}^{- at} . sin ( wt ) & t \geq {T}_{d}\end{matrix} ; ,$$

wherein:
   T_{d} may be a time delay associated with time taken for an input to the system to effect an output of the HVDC control system;
   ΔI_{d} may be a change in dc current associated with the HVDC control system from an initial operating point or position;

$$a = \frac{1}{{T}_{1}} ;$$

wherein T₁ may be the time it takes a decaying waveform associated with the HVDC control system to reach e⁻¹ of its final value.

$$w = \frac{2 π}{{T}_{2}} ;$$

wherein T₂ may be the period of a superimposed ac waveform; and
k may be a constant.

The second time domain current equation may be used for HVDC control systems where a rectifier effective short circuit ratio is greater than approximately 2.6.

The constant k may have a value between zero and 1, preferably 0.25.

The time domain voltage equation may be a first time domain voltage equation:

$$Δ {V}_{d} ( t ) = \{ \begin{matrix}0 & t < {T}_{d} \\ Δ {V}_{d} ( 1 - {e}^{- at} ) & t \geq {T}_{d}\end{matrix} ; and ,$$

wherein
   T_{d} may be a time delay associated with time taken for an input to the HVDC control system to effect an output of the HVDC control system;
   ΔV_{d} may be a change in dc voltage in the HVDC control system; and

$$a = \frac{1}{{T}_{1}} ,$$

wherein:
   T₁ may be the time it takes a decaying waveform associated with the HVDC control system to reach e⁻¹ of its final value.

The time domain voltage equation may be a second time domain voltage equation:

$$Δ {V}_{d} ( t ) = \{ \begin{matrix}0 & t < {T}_{d} \\ Δ {V}_{d} ( 1 - {e}^{- at} . cos ( wt ) ) & t \geq {T}_{d}\end{matrix} ,$$

wherein:
   T_{d} may be a time delay associated with time taken for an input to the HVDC control system to effect an output of the HVDC control system;
   ΔV_{d} may be a change in dc voltage of the HVDC control system;

$$a = \frac{1}{{T}_{1}} ,$$

wherein T₁ may be the time it takes a decaying waveform associated with the HVDC control system to reach e⁻¹ of its final value; and

$$w = \frac{2 π}{{T}_{2}} ,$$

wherein T₂ may be the period of a superimposed ac waveform.

The method may comprise determining a voltage control plant transfer function for at least an inverter of the classic HVDC control system by using the second time domain voltage equation.

The method may comprise:
determining a Laplace transform of the time domain current equation;
determining a Laplace transform of a rectifier firing angle of the HVDC control system; and
determining a rectifier current control plant transfer function of the HVDC control system by determining a ratio of the determined Laplace transform of the time domain current equation and the determined Laplace transform of the rectifier firing angle.

The rectifier current control plant transfer function may be given by the equation:

$${P}_{cr} ( s ) = \frac{Δ {I}_{dr}}{{Δα}_{r}} . {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$

wherein:
   T_{d} may be a time delay associated with time taken for an input to the HVDC control system to effect an output of the HVDC control system;
   ΔI_{d} may be a change in the dc current;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of a superimposed ac waveform;
Δαᵣ may be a change in the rectifier firing angle; and

$${k}_{cr} = \frac{Δ {I}_{dr}}{{Δα}_{r}}$$

may be a gain of the rectifier control plant transfer function.

The method may comprise using the rectifier current control plant transfer function to design or facilitate design of a rectifier current controller for the HVDC control system.

The method may further comprise:
determining a Laplace transform of the time domain current equation;
determining a Laplace transform of an inverter firing angle of the HVDC control system; and
determining an inverter current control plant transfer function of the HVDC control system by determining a ratio of the determined Laplace transform of the time domain current equation and the determined Laplace transform of the inverter firing angle.

The inverter current control plant transfer function may be given by the equation:

$${P}_{ci} ( s ) = \frac{Δ {I}_{di}}{{Δα}_{i}} \cdot {e}^{- {T}_{d} s} ( \frac{\begin{matrix}{s}^{3} + ( 3 a - 1 ) {s}^{2} + \\ ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$

wherein:
   T_{d} may be a time delay associated with time taken for an input to the HVDC control system to effect an output of the HVDC control system;
   ΔI_{d}_{ᵢ} may be a change in the dc current;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of a superimposed ac waveform;
Δαᵢ may be a change in the inverter firing angle; and

$${k}_{ci} = \frac{Δ {I}_{di}}{{Δα}_{i}}$$

may be a gain of the inverter control plant transfer function.

The method may comprise using the inverter current control plant transfer function to design or facilitate design of an inverter current controller for the HVDC control system.

The method may further comprise:
determining a Laplace transform of the time domain voltage equation;
determining a Laplace transform of the rectifier firing angle of the HVDC control system; and
determining a rectifier voltage control plant transfer function of the HVDC control system by determining a ratio of the determined Laplace transform of the time domain voltage equation and the determined Laplace transform of the rectifier firing angle.

The rectifier voltage control plant transfer function may be given by the equation:

$${P}_{vr} ( s ) = \frac{Δ {V}_{dr}}{{Δα}_{r}} \frac{1}{s + a} {e}^{- {T}_{d} \cdot s} .$$

wherein:
   T_{d} may be a time delay associated with time taken for an input to the HVDC control system to effect an output of the HVDC control system;

$$a = \frac{1}{{T}_{1}} ,$$

wherein T₁ may be a time it takes the decaying waveform associated with the HVDC control system to reach e⁻¹ of its final value; and

$${k}_{vr} = \frac{Δ {V}_{dr}}{Δ {α}_{r}}$$

may be a gain of the rectifier voltage control plant transfer function.

The rectifier voltage control plant transfer function may be used to design or facilitate design of a rectifier voltage controller for the HVDC control system.

The method may further comprise:
determining a Laplace transform of the second time domain voltage equation;
determining a Laplace transform of the inverter firing angle of the HVDC control system; and
determining an inverter voltage control plant transfer function of the HVDC control system by determining a ratio of the determined Laplace transform of the second time domain voltage equation and the determined Laplace transform of the inverter firing angle.

The inverter voltage control plant transfer function may be given by the equation:

$${P}_{vi} ( s ) = \frac{Δ {V}_{di}}{{Δα}_{i}} \frac{w}{{( s + a )}^{2} + {w}^{2}} {e}^{- {T}_{d} \cdot s} . ,$$

wherein:
   T_{d} may be a time delay associated with time taken for an input to the HVDC control system to effect an output of the HVDC control system;
   ΔV_{di} may be a change in DC voltage of the HVDC control system;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of the superimposed ac waveform; and

$${k}_{vi} = \frac{Δ {V}_{di}}{Δ {α}_{i}}$$

may be the gain of the inverter voltage control plant transfer function.

The inverter voltage control plant transfer function may be used to design or facilitate design of an inverter voltage controller for the HVDC control system.

The method may further comprise using a QFT (Quantitative Feedback Theory) approach to design the HVDC control system.

According to a second aspect of the invention, there is provided a system for facilitating design of a High Voltage Direct Current (HVDC) control system, the system comprising:
a memory for storing data;
a processor operatively connected to the memory, the processor including:
   a current control plant transfer function determining module configured to determine at least a current control plant transfer function for a rectifier and/or inverter of the classic HVDC control system by using a time domain current equation;
   a voltage control plant transfer function determining module configured to determine at least a voltage control plant transfer function for a rectifier and/or inverter of the classic HVDC control system by using a time domain voltage equation; and
   a design module configured to use the determined current control plant transfer function for the rectifier and/or inverter, and/or the determined voltage control plant transfer function for the rectifier or inverter to facilitate design of the HVDC control system.

The current control plant transfer function determining module may be configured to use the following first time domain current equation to determine the current control plant transfer function for the rectifier and/or inverter:

$${I}_{dr} ( t ) = \{ \begin{matrix}1 \cdot 1 \cdot m \cdot ( Δ {I}_{d} - {I}_{d 1} ) \cdot ( 1 - {e}^{- bt} ) & 0 < t < {T}_{o} \\ 1 \cdot 1 \cdot m \cdot ( Δ {I}_{d} - {I}_{d 1} ) ( 1 - {e}^{- b \cdot t} ) + {I}_{d 1} \cdot ( n - p \cdot k \cdot {e}^{- a . t} + c \cdot k \cdot {e}^{- a \cdot t} \cdot ( sin ( wt ) - m \cdot cos ( wt ) ) & t \geq {T}_{o} ,\end{matrix}$$

wherein:
   I_{d1} may be a first peak of an oscillating component of a dc current associated with the HVDC control system;
   ΔI_{d} may be a final value of the dc current from a nominalised zero reference;

$$a = \frac{r}{{T}_{1}} ,$$

wherein:
   T₁ may be a time associated with a first peak of the dc current; and
   r may be a constant;

$$w = \frac{2 π}{{T}_{2}} ,$$

wherein:
T₂ may be a first period of the oscillating component of the dc current;
k may be a constant;
T_{∞} may be a time which the HVDC control system takes to reach a final value;

$$b = \frac{log ( \frac{1}{11} ) - log ( 1 - \frac{10 \cdot {I}_{d 1} ( 1 - {e}^{- 1} )}{11 \cdot Δ {I}_{d}} )}{- {T}_{∞}} ;$$

and
Tₒ may be a time delay selected at least to avoid formation of very high order models.

The current control plant transfer function determining module may be configured to use the following second time domain current equation to determine the current control plant transfer function for the rectifier and/or inverter:

$$Δ {I}_{d} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d}\end{matrix} ; ,$$

wherein:
   T_{d} may be a time delay associated with time taken for an input to the system to effect an output of the HVDC control system;
   ΔI_{d} may be a change in dc current associated with the HVDC control system from an initial operating point or position;

$$a = \frac{1}{{T}_{1}} ;$$

wherein T₁ may be the time it takes a decaying waveform associated with the HVDC control system to reach e⁻¹ of its final value.

$$w = \frac{2 π}{{T}_{2}} ;$$

wherein T₂ is the period of a superimposed ac waveform; and
k may be a constant.

The voltage control plant transfer function determining module may be configured to use the following first time domain voltage equation to determine at least a voltage control plant transfer function for a rectifier:

$$Δ {V}_{d} ( t ) = \{ \begin{matrix}0 & t < {T}_{d} \\ Δ {V}_{d} ( 1 - {e}^{- at} ) & t \geq {T}_{d}\end{matrix} ; and ,$$

wherein
   T_{d} may be a time delay associated with time taken for an input to the HVDC control system to effect an output of the HVDC control system;
   ΔV_{d}_{ᵢ} i may be a change in dc voltage in the HVDC control system; and

$$a = \frac{1}{{T}_{1}} ,$$

wherein:
   T₁ may be the time it takes a decaying waveform associated with the HVDC control system to reach e⁻¹ of its final value.

The voltage control plant transfer function determining module may be configured to use the following second time domain voltage equation to determine at least a voltage control plant transfer function for an inverter:

$$Δ {V}_{d} ( t ) = \{ \begin{matrix}0 & t < {T}_{d} \\ Δ {V}_{d} \cdot ( 1 - {e}^{- at} \cdot cos ( wt ) ) & t \geq {T}_{d}\end{matrix} ,$$

wherein:
   T_{d} may be a time delay associated with time taken for an input to the HVDC control system to effect an output of the HVDC control system;
   ΔV_{d} may be a change in dc voltage of the HVDC control system;

$$a = \frac{1}{{T}_{1}} ,$$

wherein T₁ may be the time it takes a decaying waveform associated with the HVDC control system to reach e⁻¹ of its final value; and

$$w = \frac{2 π}{{T}_{2}} ,$$

wherein T₂ may be the period of a superimposed ac waveform.

The current control plant transfer function determining module is configured to:
determine a Laplace transform of the time domain current equation;
determine a Laplace transform of a rectifier firing angle of the HVDC control system; and
determine a rectifier current control plant transfer function of the HVDC control system by determining a ratio of the determined Laplace transform of the time domain current equation and the determined Laplace transform of the rectifier firing angle.

The determined rectifier current control plant transfer function may be given by the equation:

$${P}_{cr} ( s ) = \frac{Δ {I}_{dr}}{{Δα}_{r}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$

wherein:
   T_{d} may be a time delay associated with time taken for an input to the HVDC control system to effect an output of the HVDC control system;
   ΔI_{d} may be a change in the dc current;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of a superimposed ac waveform;
Δαᵣ may be a change in the rectifier firing angle; and

$${k}_{cr} = \frac{Δ {I}_{dr}}{Δ {α}_{r}}$$

may be a gain of the rectifier control plant transfer function.

The current control plant transfer function determining module may be configured to:
determine a Laplace transform of the time domain current equation;
determine a Laplace transform of an inverter firing angle of the HVDC control system; and
determine an inverter current control plant transfer function of the HVDC control system by determining a ratio of the determined Laplace transform of the time domain current equation and the determined Laplace transform of the inverter firing angle.

The determined inverter current control plant transfer function may be given by the equation:

$${P}_{ci} ( s ) = \frac{Δ {I}_{di}}{{Δα}_{i}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$

wherein:
   T_{d} may be a time delay associated with time taken for an input to the HVDC control system to effect an output of the HVDC control system;
   ΔI_{di} may be a change in the dc current;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of a superimposed ac waveform;
Δαᵢ is a change in the inverter firing angle; and

$${k}_{ci} = \frac{Δ {I}_{di}}{Δ {α}_{i}}$$

may be a gain of the inverter control plant transfer function.

The voltage control plant transfer function determining module may be configured to:
determine a Laplace transform of the time domain voltage equation;
determine a Laplace transform of the rectifier firing angle of the HVDC control system; and
determine a rectifier voltage control plant transfer function of the HVDC control system by determining a ratio of the determined Laplace transform of the time domain voltage equation and the determined Laplace transform of the rectifier firing angle.

The determined rectifier voltage control plant transfer function may be given by the equation:

$${P}_{vr} ( s ) = \frac{Δ {V}_{dr}}{Δ {α}_{r}} \frac{1}{s + a} {e}^{- {T}_{d} \cdot s} ,$$

wherein:
   T_{d} is a time delay associated with time taken for an input to the HVDC control system to effect an output of the HVDC control system;

$$a = \frac{1}{{T}_{1}} ,$$

wherein T₁ may be a time it takes the decaying waveform associated with the HVDC control system to reach e⁻¹ of its final value; and

$${k}_{vr} = \frac{Δ {V}_{dr}}{Δ {α}_{r}}$$

may be a gain of the rectifier voltage control plant transfer function.

The voltage control plant transfer function determining module may be configured to:
determine a Laplace transform of the second time domain voltage equation;
determine a Laplace transform of the inverter firing angle of the HVDC control system; and
determining an inverter voltage control plant transfer function of the HVDC control system by determining a ratio of the determined Laplace transform of the second time domain voltage equation and the determined Laplace transform of the inverter firing angle.

The determined inverter voltage control plant transfer function may be given by the equation:

$${P}_{vi} ( s ) = \frac{Δ {V}_{di}}{Δ {α}_{i}} \frac{w}{{( s + a )}^{2} + {w}^{2}} {e}^{- {T}_{d} \cdot s} . ,$$

wherein:
   T_{d} may be a time delay associated with time taken for an input to the HVDC control system to effect an output of the HVDC control system;
   ΔV_{di} may be a change in DC voltage of the HVDC control system;

$$a = \frac{1}{{T}_{1}} ,$$

wherein T₁ may be the time it takes the decaying waveform associated with the HVDC control system to reach e⁻¹ of its final value;

$$w = \frac{2 π}{{T}_{2}} ,$$

wherein T₂ may be the period of the superimposed ac waveform; and

$${k}_{vi} = \frac{Δ {V}_{di}}{Δ {α}_{i}}$$

may be the gain of the inverter voltage control plant transfer function.

The design module may be configured to use a QFT (Quantitative Feedback Theory) approach to design the HVDC control system.

According to a third aspect of the invention, there is provided a method of facilitating design of a classic High Voltage Direct Current (HVDC) control system, the method comprising:
using a rectifier current control plant transfer function:

$${P}_{cr} ( s ) = \frac{Δ {I}_{dr}}{Δ {α}_{r}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$

wherein:
key output parametric variables are:
T_{d} is a time delay associated with time taken for an input to the HVDC control system to effect an output of the HVDC control system;
ΔI_{d} is a change in the dc current;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of a superimposed ac waveform;
Δαᵣ is a change in the rectifier firing angle; and

$${k}_{cr} = \frac{Δ {I}_{dr}}{Δ {α}_{r}}$$

is a gain of the rectifier control plant transfer function, to design a rectifier current controller for the HVDC control system;
using an inverter current control plant transfer function:

$$Δ {P}_{ci} ( s ) = \frac{Δ {I}_{di}}{Δ {α}_{i}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$

wherein:
   T_{d} is a time delay associated with time taken for an input to the HVDC control system to effect an output of the HVDC control system;
   ΔI_{di} is a change in the dc current;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of a superimposed ac waveform;
Δαᵢ is a change in the inverter firing angle; and

$${k}_{ci} = \frac{Δ {I}_{di}}{Δ {α}_{i}}$$

is a gain of the inverter control plant transfer function, to design an inverter current controller for the HVDC control system;
using a rectifier voltage control plant transfer function:

$${P}_{vr} ( s ) = \frac{Δ {V}_{dr}}{Δ {α}_{r}} \frac{1}{s + a} {e}^{- {T}_{d} \cdot s} ,$$

wherein:
   T_{d} is a time delay associated with time taken for an input to the HVDC control system to effect an output of the HVDC control system;

$${P}_{vr} ( s ) = \frac{Δ {V}_{dr}}{Δ {α}_{r}} \frac{1}{s + a} {e}^{- {T}_{d} \cdot s} ,$$

wherein T₁ is a time it takes the decaying waveform associated with the HVDC control system to reach e⁻¹ of its final value; and

$${k}_{vr} = \frac{Δ {V}_{dr}}{{Δα}_{r}}$$

is a gain of the rectifier voltage control plant transfer function
to design a rectifier voltage controller for the HVDC control system; and
using an inverter voltage control plant transfer function:

$${P}_{vi} ( s ) = \frac{Δ {V}_{di}}{Δ {α}_{i}} \frac{w}{{( s + a )}^{2} + {w}^{2}} {e}^{- {T}_{d} \cdot s} ,$$

wherein:
T_{d} is a time delay associated with time taken for an input to the HVDC control system to effect an output of the HVDC control system;
ΔV_{di} is a change in DC voltage of the HVDC control system;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of the superimposed ac waveform; and

$${k}_{vi} = \frac{Δ {V}_{di}}{{Δα}_{i}}$$

is the gain of the inverter voltage control plant transfer function,
to design an inverter voltage controller for the HVDC control system.

According to a third aspect of the invention there is provided, a system for facilitating design of a classic High Voltage Direct Current (HVDC) control system, the system comprising:
a memory for storing data;
a processor operatively connected to the memory, the processor including:
a design module arranged to:
   use a rectifier current control plant transfer function:

$${P}_{cr} ( s ) = \frac{Δ {I}_{dr}}{{Δα}_{r}} \cdot {e}^{- {T}_{d} \cdot s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$

wherein:
   key output parametric variables are:
   T_{d} is a time delay associated with time taken for an input to the HVDC control system to effect an output of the HVDC control system;
   ΔI_{d} is a change in the dc current;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of a superimposed ac waveform;
Δαᵣ is a change in the rectifier firing angle; and

$${k}_{cr} = \frac{Δ {I}_{dr}}{{Δα}_{r}}$$

is a gain of the rectifier control plant transfer function,
to design a rectifier current controller for the HVDC control system;
use an inverter current control plant transfer function:

$${P}_{ci} ( s ) = \frac{Δ {I}_{di}}{{Δα}_{i}} \cdot {e}^{- {T}_{d} \cdot s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$

wherein:
   T_{d} is a time delay associated with time taken for an input to the HVDC control system to effect an output of the HVDC control system;
   ΔI_{d}_{ᵢ} is a change in the dc current;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of a superimposed ac waveform;
Δαᵢ is a change in the inverter firing angle; and

$${k}_{ci} = \frac{Δ {I}_{di}}{{Δα}_{i}}$$

is a gain of the inverter control plant transfer function,
to design an inverter current controller for the HVDC control system;
use a rectifier voltage control plant transfer function:

$${P}_{vr} ( s ) = \frac{Δ {V}_{dr}}{Δ {α}_{r}} \frac{1}{s + a} {e}^{- {T}_{d} \cdot s} ,$$

wherein:
   T_{d} is a time delay associated with time taken for an input to the HVDC control system to effect an output of the HVDC control system;

$$a = \frac{1}{{T}_{1}} ,$$

wherein T₁ is a time it takes the decaying waveform associated with the HVDC control system to reach e⁻¹ of its final value; and

$${k}_{vr} = \frac{Δ {V}_{dr}}{Δ α}$$

is a gain of the rectifier voltage control plant transfer function
to design a rectifier voltage controller for the HVDC control system; and
using an inverter voltage control plant transfer function:

$${P}_{vi} ( s ) = \frac{Δ {V}_{di}}{{Δα}_{i}} \frac{v}{{( s + a )}^{2} + {w}^{2}} {e}^{- {T}_{d} , s} ,$$

wherein:
   T_{d} is a time delay associated with time taken for an input to the HVDC control system to effect an output of the HVDC control system;
   ΔV_{di} is a change in DC voltage of the HVDC control system;

$$a = \frac{1}{{T}_{1}} ,$$

wherein T₁ is the time it takes the decaying waveform associated with the HVDC control system to reach e⁻¹ of its final value;

$$w = \frac{2 π}{{T}_{2}} ,$$

wherein T₂ is the period of the superimposed ac waveform; and

$${k}_{vi} = \frac{Δ {V}_{di}}{Δ {α}_{i}}$$

is the gain of the inverter voltage control plant transfer function,
to design an inverter voltage controller for the HVDC control system.

According to a fourth aspect of the invention, there is provided a method for optimising a classic High Voltage Direct Current (HVDC) control system, the method comprising:
determining at least an optimised current control plant transfer function for a rectifier and/or inverter of the classic HVDC control system by using at least a time domain current equation:
determining at least an optimised voltage control plant transfer function for a rectifier and/or inverter of the classic HVDC control system by using a time domain voltage equation:
and
using the determined optimised current control plant transfer function for the rectifier and/or inverter, and/or the determined optimised voltage control plant transfer function for the rectifier and/or inverter to optimise the HVDC control system.

The time domain current equation may be a first time domain current equation:

$${I}_{dr} ( t ) = \{ \begin{matrix}1 \cdot 1 \cdot m ( Δ {I}_{d} - {I}_{d 1} ) \cdot ( 1 - {e}^{- bt} ) & 0 < t < {T}_{o} \\ 1 \cdot 1 \cdot m ( Δ {I}_{d} - {I}_{d 1} ) ( 1 - {e}^{- b , t} ) + {I}_{d 1} \cdot ( \begin{matrix}\begin{matrix}n - p \cdot k \cdot {e}^{- α , t} + \\ c \cdot k \cdot {e}^{- α , t} \cdot \end{matrix} \\ ( \begin{matrix}sin ( wt ) - \\ m \cdot cos ( wt )\end{matrix} )\end{matrix} ) & t \geq {T}_{o} ,\end{matrix}$$

wherein:
   I_{d1} may be a first peak of an oscillating component of a dc current associated with the HVDC control system;
   ΔI_{d} may be a final value of the dc current from a nominalised zero reference;

$$a = \frac{r}{{T}_{1}} ,$$

wherein:
   T₁ may be a time associated with a first peak of the dc current; and
   r may be a constant;

$$w = \frac{2 π}{{T}_{2}} ,$$

wherein:
T₂ may be a first period of the oscillating component of the dc current;
k may be a constant;
T_{∞} may be a time which the HVDC control system takes to reach a final value;

$$b = \frac{log ( \frac{1}{11} ) - log ( 1 - \frac{10 \cdot {I}_{d 1} ( 1 - {e}^{- 1} )}{11 \cdot Δ {I}_{d}} )}{- {T}_{∞}} ;$$

and
Tₒ may be a time delay selected at least to avoid formation of very high order models.

The time domain current equation may be a second time domain current equation:

$$Δ {I}_{d} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d} ; ,\end{matrix}$$

wherein:
   T_{d} may be a time delay associated with time taken for an input to the system to effect an output of the HVDC control system;
   ΔI_{d} may be a change in dc current associated with the HVDC control system from an initial operating point or position;

$$a = \frac{1}{{T}_{1}} ;$$

wherein T₁ may be the time it takes a decaying waveform associated with the HVDC control system to reach e⁻¹ of its final value.

$$w = \frac{2 π}{{T}_{2}} ;$$

wherein T₂ may be the period of a superimposed ac waveform; and
k may be a constant.

The time domain voltage equation may be a first time domain voltage equation:

$$Δ {V}_{d} ( t ) = \{ \begin{matrix}0 & t < {T}_{d} \\ Δ {V}_{d} ( 1 - {e}^{- at} ) & t \geq {T}_{d} ;\end{matrix} \\ and ,$$

wherein
   T_{d} may be a time delay associated with time taken for an input to the HVDC control system to effect an output of the HVDC control system;
   ΔV_{d} may be a change in dc voltage in the HVDC control system; and

$$a = \frac{1}{{T}_{1}} ,$$

wherein:
   T₁ may be the time it takes a decaying waveform associated with the HVDC control system to reach e⁻¹ of its final value.

The time domain voltage equation may be a second time domain voltage equation:

$$Δ {V}_{d} ( t ) = \{ \begin{matrix}0 & t < {T}_{d} \\ Δ {V}_{d} \cdot ( 1 - {e}^{- at} \cdot cos ( wt ) ) & t \geq {T}_{d} ,\end{matrix}$$

wherein:
   T_{d} may be a time delay associated with time taken for an input to the HVDC control system to effect an output of the HVDC control system;
   ΔV_{d} may be a change in dc voltage of the HVDC control system;

$$a = \frac{1}{{T}_{1}} ,$$

wherein T₁ may be the time it takes a decaying waveform associated with the HVDC control system to reach e⁻¹ of its final value; and

$$w = \frac{2 π}{{T}_{2}} ,$$

wherein T₂ may be the period of a superimposed ac waveform.

According to a fifth aspect of the invention, there is provided an HVDC control system designed in accordance with any one or more of the methods and systems as herein before described.

### BRIEF DESCRIPTION OF THE DRAWINGS

FIG. 1 shows a schematic diagram of a system in accordance with an example embodiment operatively interfaced with an HVDC control system;

FIG. 2 shows a schematic diagram of a system of FIG. 1 in greater detail;

FIG. 3 shows a diagram of a measured DC current response;

FIG. 4 shows a diagram of a characterised DC current response;

FIG. 5 shows another diagram of a measured DC current response;

FIG. 6 shows another diagram of a characterised DC current response;

FIG. 7 shows a diagram of a measured DC voltage response;

FIG. 8 shows a diagram of a characterised DC voltage response;

FIG. 9 shows another diagram of a measured DC voltage response;

FIG. 10 shows another diagram of a characterised DC voltage response;

FIG. 11 shows a diagram of a modified 6 dB design bound for the nominal rectifier current control plant transfer function;

FIG. 12 shows a diagram of a modified 6 dB design bound for the nominal inverter current control plant transfer function;

FIG. 13 shows a diagram of a modified 6 dB design bound for the nominal rectifier voltage control plant transfer function;

FIG. 14 shows a diagram of a modified 6 dB design bound for the nominal inverter voltage control plant transfer function;

FIG. 15 shows diagrams of Bode and Nichols Plots of −P_{CR}(s);

FIG. 16 shows a diagram of the influence of the designed PI controller on P_{CR}(s);

FIG. 17 shows a diagram of a rectifier DC current response;

FIG. 18 shows more diagrams of Bode and Nichols Plots of −P_{CI}(s);

FIG. 19 shows another diagram of the influence of the designed PI controller on P_{CI}(s);

FIG. 20 shows a diagram of an inverter DC current response;

FIG. 21 shows a diagram of a start-up response of the classic HVDC system of FIG. 1;

FIG. 22 shows a flow diagram of a method of facilitating design of a classic High Voltage Direct Current (HVDC) control system in accordance with an example embodiment;

FIG. 23 shows another flow diagram of designing a classic High Voltage Direct Current (HVDC) control system in accordance with an example embodiment;

FIG. 24 shows a diagram of a measured rectifier DC current response in accordance with an example embodiment;

FIG. 25 shows a diagram of a time delay definition in accordance with an example embodiment; and

FIG. 26 shows a diagrammatic representation of a machine in the example form of a computer system in which a set of instructions for causing the machine to perform any one or more of the methodologies discussed herein, may be executed.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

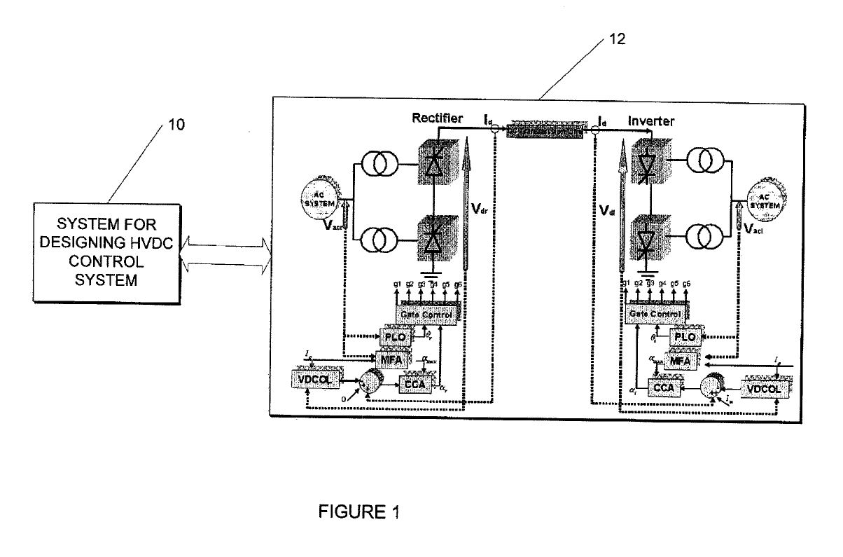

Referring to FIGS. 1 to 21, 24 and 25 of the drawings where a system for facilitating design of a High Voltage Direct Current (HVDC) control system in accordance with an example embodiment is generally indicated by reference numeral 10. The system 10 is advantageously configured at least to facilitate designing a HVDC control system 12 as illustrated in FIG. 1 for example.

The system 10 comprises a processor 14 operatively connected to a memory 16. The memory 16 may include a machine-readable medium, e.g. memory in the processor 14, main memory, and/or hard disk drive, which carries a set of instructions to direct the operation of the processor 14. It is to be understood that the processor 14 may be one or more microprocessors, controllers, or any other suitable computing device, resource, hardware, software, or embedded logic.

The processor 14 further comprises a plurality of components or modules which correspond to the functional tasks to be performed by the system 10. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices.

In particular, the processor 14 comprises a current control plant transfer function determining module 18 configured to determine at least a current control plant transfer function for a rectifier and/or inverter of the classic HVDC system 12 by using a first or a second time domain current equation.

The first time domain current equation may be given as:

$${I}_{dr} ( t ) = \{ \begin{matrix}1.1 \cdot m \cdot ( Δ {I}_{d} - {I}_{d 1} ) \cdot ( 1 - {e}^{- bt} ) & 0 < t < {T}_{o} \\ \begin{matrix}1.1 \cdot m \cdot ( Δ {I}_{d} - {I}_{d 1} ) ( 1 - {e}^{- b \cdot t} ) + \\ {I}_{d 1} \cdot ( n - p \cdot k \cdot {e}^{- a \cdot t} + c \cdot k \cdot {e}^{- a \cdot t} \cdot ( sin ( wt ) - m cos ( wt ) )\end{matrix} & t \geq {T}_{o} ,\end{matrix} \qquad ( A )$$

wherein:
   I_{d1} is a first peak of an oscillating component of a dc current (p.u.) associated with the HVDC control system;
   ΔI_{d} is a final value of the dc current (p.u.) from a nominalised zero reference;

$$a = \frac{r}{{T}_{1}} ,$$

wherein:
   T₁ is a time (sec) associated with a first peak of the dc current (p.u.).r; and
   r is a constant;

$$w = \frac{2 π}{{T}_{2}} ,$$

wherein:
T₂ is a first period (sec) of the oscillating component of the dc current;
k is a constant; (between 0 and 1, preferably 0.25)
T_{∞} is a time which the HVDC control system takes to reach a final value;

$$b = \frac{log ( \frac{1}{11} ) - log ( 1 - \frac{10 \cdot {I}_{d 1} ( 1 - {e}^{- 1} )}{11 \cdot Δ {I}_{d}} )}{- {T}_{∞}} ;$$

and
Tₒ is a time delay (sec) selected at least to avoid formation of very high order models.

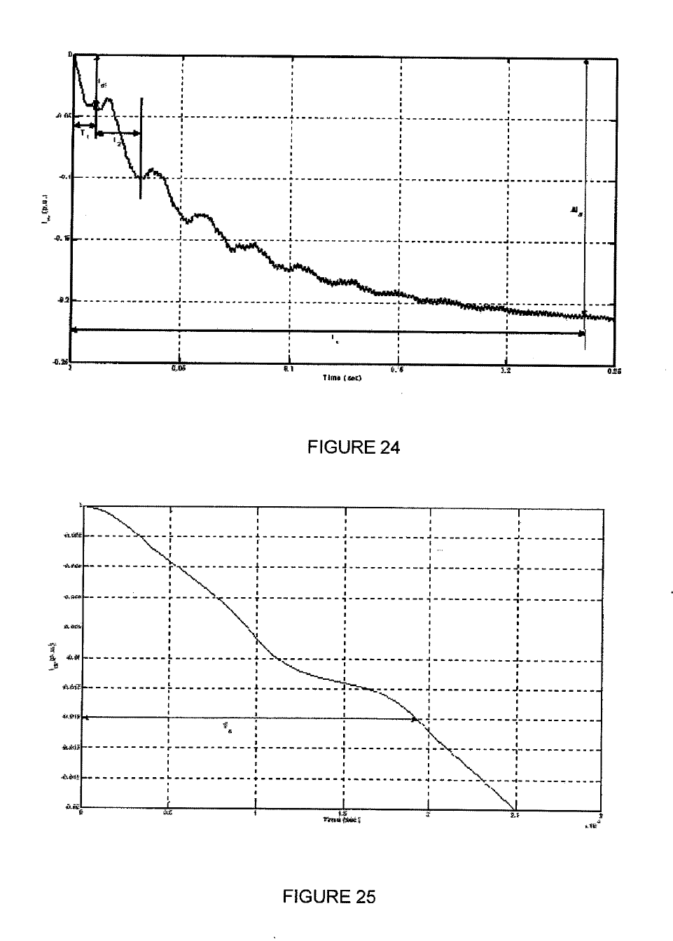

A measured rectifier dc current response corresponding to equation (A), viz. the first time domain current formula, is illustrated in FIG. 24 whereas a time delay definition of Tₒ is illustrated in FIG. 25 for ease of reference.

In any event, the second time domain current equation may be given as:

$$Δ {I}_{d} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d}\end{matrix} \qquad ( 1 )$$

where T_{d} is the time delay (sec)
   ΔI_{d} is the change in the DC current (p.u.)

$$a = \frac{1}{{T}_{1}}$$

T₁ is defined as the time (sec) it takes the decaying waveform to reach e⁻¹ of its final value.

$$w = \frac{2 π}{{T}_{2}}$$

T₂ is defined as the period (sec) of the superimposed as AC waveform.
k is constant (0<k≦1) chosen to be 0.25.

For brevity, the words equation, formula, and function will be used interchangeably in the specification.

Equation (A) may conveniently be used to obtain rectifier current control plant transfer functions only. However, in other example embodiments, the principles introduced by Equation (A) may be extended to other areas such as inverter current control plant transfer functions, etc.

In any event, it will be note that the Equation (A) has a wide range of operation and use as it advantageously may be used to determine rectifier current control plant transfer functions for varying values or ranges of rectifier effective short circuit ratios (discussed below). In particular, for rectifier effective short circuit ratios greater than approximately 2.6 then:

$$m = 0 ; n = \frac{Δ {I}_{d}}{{I}_{d 1}} ; p = \frac{Δ {I}_{d}}{k \cdot {I}_{d 1}} ; 0 < r < 1 ; and c = \frac{Δ {I}_{d}^{2}}{{I}_{d 1}} .$$

It follows that Equation (A) approximates Equation (1) substantially in cases where the rectifier effective short circuit ratio is greater than 2.6.

However, for rectifier effective short circuit ratio less than approximately 2.6, then: m=1; n=1; r=1; q=1; and c=1.

In any event, in light of the brief discussion above and more importantly for ease of explanation, reference will now only be made to Equation (1) and cases where the rectifier effective short circuit ratio is greater than 2.6. However, it will be appreciated by those skilled in the art that similar operations and consideration made with specific reference to Equation (1) may easily be extended to Equation (A).

As an aside it will be understood that the normal steady-state operating point of the classic HVDC system is defined as the stable (or equilibrium) point of operation, the classic HVDC system can be considered linearised around the normal steady-state operating point.

Therefore a classic HVDC system can be considered as “linear time invariant system” around a stable operating point.

The impulse response of a “linear time invariant system” is determined by first determining the step response and then exploiting the fact that the impulse response is obtained by differentiating the step response. The Laplace transform of the impulse response is defined as the transfer function of the “linear time-invariant system”. In this regard, the current equation (1) may conveniently be the characterised DC current response. In any event, the plant transfer function can be explicitly obtained by determining the ratio of the Laplace transform of the step response to the Laplace transform of the step input.

The small signal plant transfer function of a classic HVDC system may be obtained by determining the ratio of the Laplace transform of the small signal step response of the classic HVDC system to the Laplace transform of the step input of the rectifier firing angle or inverter firing angle, as will be discussed below.

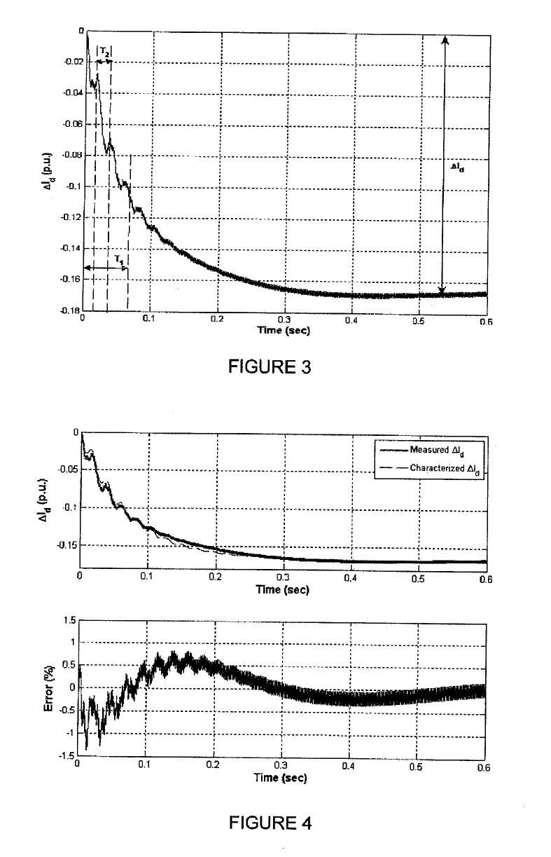

It will be noted that the measured open-loop control time domain current response is illustrated FIG. 3. The measured current response was approximated using the time domain function illustrated in equation (1).

The function described by eqn. (1) was simulated using a suitable computer simulation program and the characteristic time domain response is illustrated in FIG. 4, together with the associated error when compared to the original signal. FIG. 4 illustrates that the current equation (1) adequately approximates the dc current response to a step change in the rectifier's firing angle since the resultant error does not exceed 1.5%.

From the above discussion, in order to determine the current control plant transfer functions, the module 18 is conveniently arranged to determine a Laplace transform of the characterised DC current response or in other words the current equation (1) for the rectifier, which is given as:

$$Δ {I}_{dr} ( s ) = Δ {I}_{dr} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{s ( s + a ) ( {s}^{2} + 2 as + {a}^{2} + {w}^{2} )} ) \qquad ( 2 )$$

The module 18 is also conveniently arranged to determine the Laplace transform of a rectifier firing angle step input:

$$Δ {α}_{r} ( s ) = \frac{Δ {α}_{r}}{s} \qquad ( 3 )$$

Therefore, it follows that the module 18 is arranged to determine the rectifier current control plant transfer function:

$${P}_{cr} ( s ) = \frac{Δ {I}_{dr}}{Δ {α}_{r}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) \qquad ( 4 )$$

In the above equation the key output parametric variables are:
T_{d} is the time delay (sec);
ΔI_{d} is the change in the DC current (p.u.)

$$a = \frac{1}{{T}_{1}}$$

T₁ is defined as the time (sec) it takes the decaying waveform to reach e⁻¹ of its final value;

$$w = \frac{2 π}{{T}_{2}}$$

T₂ is defined as the period (sec) of the superimposed AC waveform;
Δαᵣ is the change in the rectifier firing angle (°); and

$${k}_{cr} = \frac{Δ {I}_{dr}}{Δ {α}_{r}}$$

is gain of the plant transfer function (p.u./°).

The processor 14 conveniently comprises a design module 22 configured to use the rectifier current control plant transfer function (4) to design or facilitate design of a rectifier current controller for the HVDC control system 12 much easier than conventional methodologies and/or systems.

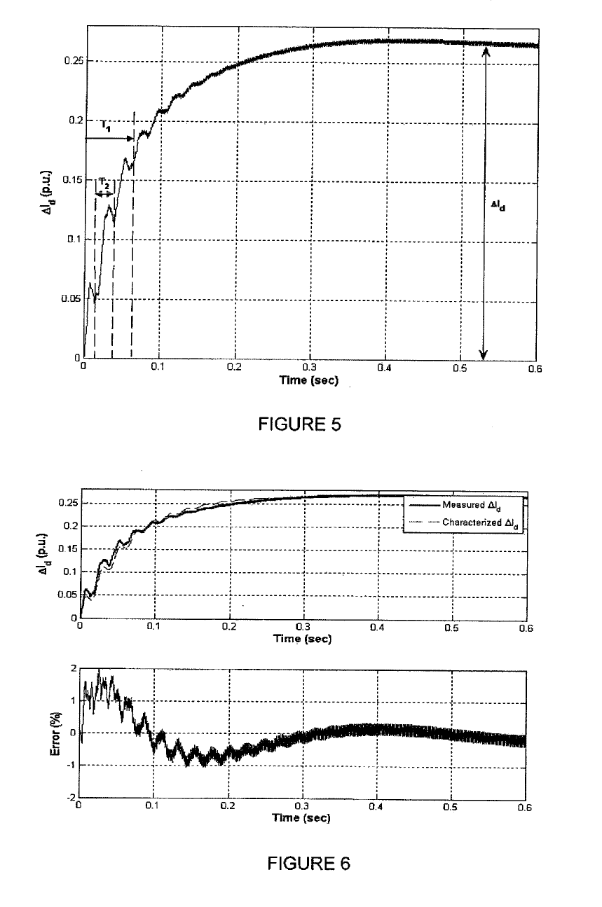

Referring now to FIG. 5 of the drawings where the measured open-loop control time domain current response is illustrated. The measured current response was approximated using the current equation (1) as described in equation (5) for the inverter of the HVDC control system 12:

$$Δ {I}_{di} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d}\end{matrix} \qquad ( 5 )$$

The current equation (5) was again simulated and a characteristic time domain response associated therewith is illustrated in FIG. 6, together with an associated error when compared to the original signal. FIG. 6 clearly illustrates that the current equation (5) adequately approximates the DC current response to a step change in the inverter's firing angle since the resultant error does not exceed 2.0%.

The module 18 is arranged to determine a Laplace transform of the characterized DC current response given by equation (5), which Laplace transform is given by the following equation:

$$Δ {I}_{di} ( s ) = Δ {I}_{di} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{s ( s + a ) ( {s}^{2} + 2 as + {a}^{2} + {w}^{2} )} ) \qquad ( 6 )$$

The module 18 is also arranged to determine a Laplace transform of an inverter firing angle step input:

$$Δ {α}_{i} ( s ) = \frac{Δ {α}_{i}}{s} \qquad ( 7 )$$

Therefore, it follows that the module 18 is arranged to determine the inverter current control plant transfer function:

$${P}_{ci} ( s ) = \frac{Δ {I}_{di}}{Δ {α}_{i}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) \qquad ( 8 )$$

In the above equation the key output parametric variables are T_{d}, ΔI_{di}, a, w, Δαᵢ and

$${k}_{ci} = \frac{Δ {I}_{di}}{Δ {α}_{i}}$$

is gain of the plant transfer function (p.u./°).

It will be noted that the design module 22 is configured to use the inverter current control plant transfer function (8) to design or facilitate design of an inverter current controller for the HVDC control system 12 much easier than conventional methodologies and/or systems.

The processor 14 also comprises a voltage control plant transfer function determining module 20 configured to determine at least a voltage control plant transfer function for at least a rectifier of the classic HVDC system 12 by using a first voltage equation:

$$Δ {V}_{d} ( t ) = \{ \begin{matrix}0 & t < {T}_{d} \\ Δ {V}_{d} ( 1 - {e}^{- at} ) & t \geq {T}_{d} .\end{matrix} \qquad ( 9 )$$

where T_{d} is the time delay (sec);
   ΔV_{d} is the change in the DC current (p.u.); and

$$a = \frac{1}{{T}_{1}}$$

T₁ is defined as the time (sec) it takes the decaying waveform to reach e⁻¹ of its final value.

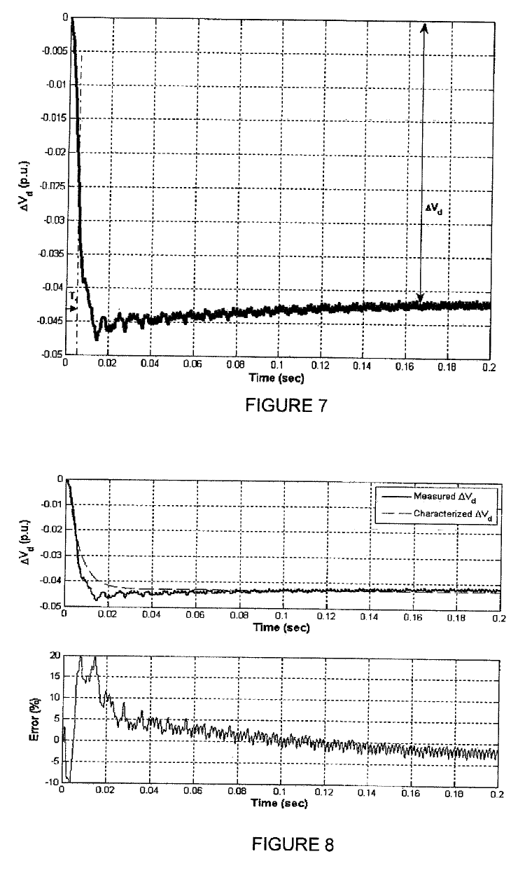

Referring to FIG. 7 where the measured open-loop control time domain voltage response is illustrated. The measured voltage response was approximated using the equation (9).

The function (9) was simulated and a characteristic time domain response is illustrated in FIG. 8, together with the associated error when compared to the original signal. In particular, FIG. 8 illustrates that equation (9) adequately approximates the DC voltage response to a step change in the rectifier's firing angle. Although there are moderate errors, in the characterized signal, these errors are high frequency signals (>100 Hz). It has been shown that for studies involving of the most of the HVDC phenomena, a frequency range less than 100 Hz on the DC side is of interest.

A visual analysis of the error signal illuminates the fact that the error is comprised of mainly high frequency signals. The largest error components are high frequency signals that have a large damping coefficient since these signals are damped out within 20 milliseconds. The remaining error is comprised of high frequency signals whose total combined magnitude is less than 5%.

The module 20 may be arranged to determine a Laplace transform of the characterized DC voltage response or in other words equation (9):

$$Δ {V}_{dr} ( s ) = \frac{Δ {V}_{dr}}{s ( s + a )} {e}^{- {T}_{d} \cdot s} \qquad ( 10 )$$

The module 20 may be arranged to determine a Laplace transform of the rectifier firing angle step input as hereinbefore described:

$$Δ {α}_{r} ( s ) = \frac{Δ {α}_{r}}{s} \qquad ( 11 )$$

Therefore, it follows that the module 20 is arranged to determine the rectifier voltage control plant transfer function:

$${P}_{vr} ( s ) = \frac{Δ {V}_{dr}}{Δ {α}_{r}} \frac{1}{s + a} {e}^{- {T}_{d} \cdot s} \qquad ( 12 )$$

In the above equation the key output parametric variables are
T_{d} is the time delay (sec);

$$a = \frac{1}{{T}_{1}}$$

T₁ is defined as the time (sec) it takes the decaying waveform to reach e⁻¹ of its final value; and

$${k}_{vr} = \frac{Δ {V}_{dr}}{Δ {α}_{r}}$$

is gain of the plant transfer function (p.u./°).

The design module 22 is configured to use the rectifier voltage control plant transfer function (12) to design or facilitate design of a rectifier voltage controller for the HVDC control system 12.

In an example embodiment, the voltage equation may be a second voltage equation:

$$Δ {V}_{d} ( t ) = \{ \begin{matrix}0 & t < {T}_{d} \\ Δ {V}_{d} \cdot ( 1 - {e}^{- at} \cdot cos ( wt ) ) & t \geq {T}_{d}\end{matrix} \qquad ( 13 )$$

where T_{d} is the time delay (sec);
   ΔV_{d} is the change in the DC voltage (p.u.);

$$a = \frac{1}{{T}_{1}}$$

T₁ is defined as the time (sec) it takes the decaying waveform to reach e⁻¹ of its final value; and

$$w = \frac{2 π}{{T}_{2}}$$

T₂ is defined as the period (sec) of the superimposed as AC waveform.

The voltage control plant transfer function determining module 20 may therefore be configured to use the voltage equation (13) to determine a voltage control plant transfer function for at least an inverter of the classic HVDC system 12.

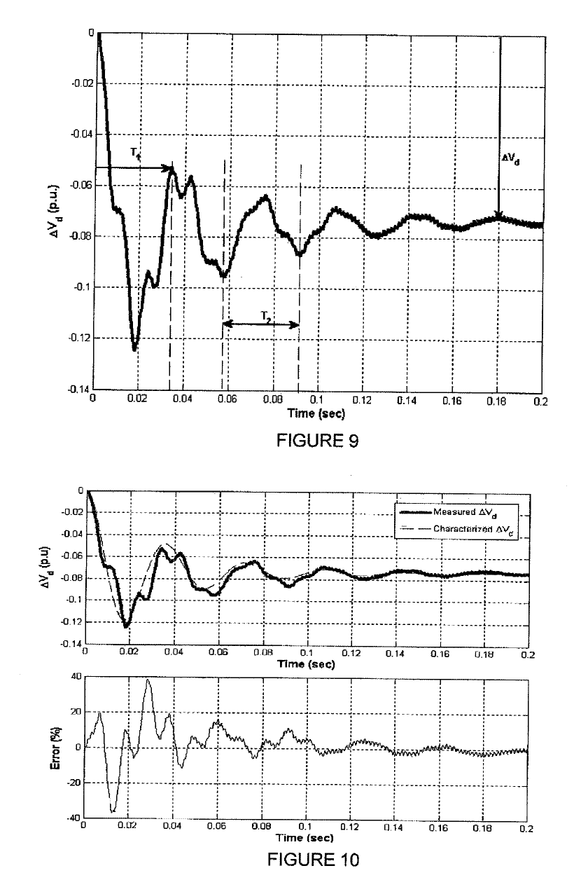

Referring to FIG. 9 of the drawings where a measured open loop control time domain voltage response is illustrated. The measured voltage response was approximated using the time domain function or in other words the voltage equation (13).

The voltage equation (13) was also simulated and a characteristic time domain response is illustrated in FIG. 10, together with the associated error when compared to the original signal.

FIG. 10 illustrates that the voltage equation (13) adequately approximates the DC voltage response to a step change in the inverter's firing angle. Although there are moderate errors, in the characterized signal, these errors are high frequency signals (>100 Hz). A visual analysis of the error signal illuminates the fact that the error is comprised of mainly high frequency signals. The largest error components are high frequency signals that have a large damping coefficient since these signals are damped out within 50 milliseconds. The remaining error is comprised of high frequency signals whose total combined magnitude is less than 5%.

The module 20 is conveniently arranged to determine a Laplace transform of the characterized DC voltage response or in other words equation 13:

$$Δ {V}_{di} ( s ) = \frac{w \cdot Δ {V}_{di}}{s [ {( s + a )}^{2} + {w}^{2} ]} {e}^{- {T}_{d} \cdot s} \qquad ( 14 )$$

The module 20 may be arranged to determine a Laplace transform of the inverter firing angle step input as hereinbefore described:

$$Δ {α}_{i} ( s ) = \frac{Δ {α}_{i}}{s} \qquad ( 15 )$$

The module 20 is therefore further arranged to determine an inverter voltage control plant transfer function:

$${P}_{vi} ( s ) = \frac{Δ {V}_{di}}{Δ {α}_{i}} \frac{w}{{( s + a )}^{2} + {w}^{2}} {e}^{- {T}_{d} \cdot s} \qquad ( 16 )$$

In the above equation the key output parametric variables are
T_{d} is the time delay (sec);
ΔV_{di} is the change in the DC voltage (p.u.);

$$a = \frac{1}{{T}_{1}}$$

T₁ is defined as the time (sec) it takes the decaying waveform to reach e⁻¹ of its final value;

$$w = \frac{2 π}{{T}_{2}}$$

T₂ is defined as the period (sec) of the superimposed as AC waveform; and

$${k}_{vi} = \frac{Δ {V}_{di}}{Δ {α}_{i}}$$

is gain of the plant transfer function (p.u./°).

The design module 22 is configured to use the inverter voltage control plant transfer function (16) to design or facilitate design of an inverter voltage controller for the HVDC control system 12 much easier than conventional methodologies and/or systems.

The current voltage control plant transfer function determining modules 18 and 20 may be arranged to store determined current and voltage control plant transfer functions for the rectifier and inverter of the HVDC control system respectively in the memory 16.

The design module 22 is conveniently arranged to use the determined rectifier and inverter current control plant transfer functions (4) and (8), as well as the rectifier and inverter voltage control plant transfer functions (12) and (16) to design the HVDC control system 12, particularly the key output parametric variables, using a QFT design methodology. Instead, or in addition, another design methodology may also be used if desired.

In particular, the design module 22 is configured to determine stability design bounds of the HVDC system 12; and then further configured to determine or design the parameters of the HVDC control system 12.

It will be understood by those skilled in the art that in a preferred example embodiment, the design module 22 is configured to use the following conventional high-to-low frequency QFT design methodology:
1. The maximum possible gain cross-over frequency ω_{gc} was determined from the non-minimum phase-lag properties of the plant. This gain cross-over frequency will be attempted to be achieved by applying a proportional gain.
2. Then the magnitude of the loop transfer function will be increased, for ω approaching zero, as fast as possible. This will be achieved by applying a first-order integral term.

The determined rectifier and inverter current control plant transfer functions (4) and (8), as well as the rectifier and inverter voltage control plant transfer functions (12) and (16) may be understood to be plant transfer functions derived from time domain characterised equations which describe at least the step responses of the classic HVDC system 12. In an example embodiment, the system identification technique is based on an application of Jacobian Linearisation.

In one example embodiment, the determined rectifier and inverter current control plant transfer functions (4) and (8), as well as the rectifier and inverter voltage control plant transfer functions (12) and (16) as hereinbefore described may already be stored in the memory 16 for access by the processor 14 when designing the HVDC control system 12 as hereinbefore described. In this example embodiment, the design module 22 conveniently accesses the memory 16 to retrieve and use these transfer functions to at least design the HVDC control system 12. It follows that this example embodiment may be more convenient in that it obviates the need for the plant transfer functions to be derived at each design.

As an aside, it will be appreciated that the state of power systems change with sudden disturbances in the power system. These sudden disturbances will change the short circuit capacity of AC busbars in the power system. The factors defining the quantitative change in short circuit capacity are loss of generation, restoration of generation, loss of transmission, loss of demand and loss of reactive compensation.

Due to the diverse nature of the factors affecting the quantitative change in short circuit capacity of an AC busbar implies that the short circuit capacity at a given HVDC converter AC busbar will vary within a range. Therefore combined with the varying amount of DC power that will be transmitted on the HVDC transmission system, the effective short circuit ratio (ESCR) for a given HVDC converter station will vary within a certain range.

Due to the uncertain nature of the effective short circuit ratio of rectifier and inverter converter stations, the plant transfer functions (4, 8, 12, 16) described above will have a range of uncertainty. In this regard, the design module 22 is arranged to determine the plant transfer function parametric ranges for varying short circuit ratios.

The dynamic performance of a current controller is dependent on the strength of both the rectifier and inverter AC systems. The module 22 is therefore arranged to determine variations in the parameters of the rectifier current control plant transfer function (4), as hereinbefore described, when the rectifier converter station's and the inverter converter station's effective short circuit ratios were varied. The results of the calculations are illustrated in Table 1.

TABLE 1
Parametric Variations of Rectifier Current Control Plant Transfer
Function for Varying ESCRs

| Inverter | Rectifier | Parameters | | | | | |
|---|---|---|---|---|---|---|---|
| ESCR | ESCR | ΔI_{dr} | a | w | T_{d} | Δαᵣ | k_{cr} |
| 7.96 | 7.96 | −0.17 | 14.95 | 290.89 | 0.70 | 10.00 | −0.017 |
| 7.96 | 6.24 | −0.16 | 20.54 | 285.60 | 0.80 | 10.00 | −0.016 |
| 7.96 | 4.50 | −0.14 | 31.51 | 279.25 | 1.00 | 10.00 | −0.014 |
| 7.96 | 2.77 | −0.10 | 44.23 | 239.82 | 1.65 | 10.00 | −0.010 |
| 5.97 | 8.03 | −0.18 | 12.38 | 278.02 | 0.63 | 10.00 | −0.018 |
| 5.97 | 6.30 | −0.17 | 14.73 | 285.60 | 0.81 | 10.00 | −0.017 |
| 5.97 | 4.54 | −0.15 | 21.39 | 272.00 | 1.08 | 10.00 | −0.015 |
| 5.97 | 2.79 | −0.10 | 43.20 | 240.74 | 1.65 | 10.00 | −0.010 |
| 3.93 | 8.18 | −0.24 | 7.12 | 265.11 | 0.60 | 10.00 | −0.024 |
| 3.93 | 6.43 | −0.22 | 8.40 | 262.89 | 0.76 | 10.00 | −0.022 |
| 3.93 | 4.64 | −0.18 | 13.62 | 254.38 | 0.99 | 10.00 | −0.018 |
| 3.93 | 2.83 | −0.11 | 35.71 | 216.66 | 1.59 | 10.00 | −0.011 |

Table 1 clearly illustrates that when the rectifier converter station's ESCR varies from 2.83 to 7.96 and the inverter converter station's ESCR varies from 3.93 to 7.96, the rectifier current control plant transfer function parameters vary in the following respective ranges:

### ΔI_{dr}ε[−0.24,−0.10] (p.u.)

aε[7.12,44.23] (1/sec)
wε[216.66,290.89] (rad/s)
T_{d}ε[0.60,1.65] (msec)
k_{cr}ε[−0.024,−0.01] (p.u./°)

Similarly, the module 22 is arranged to determine variations in the parameters of the inverter current control plant transfer function (8) for varying rectifier converter station's and the inverter converter station's effective short circuit ratios. The results of the calculations are illustrated in Table 2.

TABLE 2
Parametric Variations of Inverter Current Control Plant Transfer
Function for Varying ESCRs

| Inverter | Rectifier | Parameters | | | | | |
|---|---|---|---|---|---|---|---|
| ESCR | ESCR | ΔI_{di} | a | w | T_{d} | Δαᵢ | k_{ci} |
| 7.96 | 8 | 0.27 | 15.19 | 280.50 | 0.06 | −5.00 | −0.053 |
| 8.4335 | 6 | 0.23 | 21.12 | 278.02 | 0.89 | −5.00 | −0.046 |
| 9.29 | 4 | 0.18 | 23.80 | 276.79 | 0.86 | −5.00 | −0.036 |
| 11.8 | 2 | 0.10 | 41.63 | 248.35 | 0.24 | −5.00 | −0.020 |
| 5.97 | 8 | 0.30 | 14.27 | 280.50 | 0.81 | −5.00 | −0.061 |
| 6.34 | 6 | 0.26 | 19.31 | 275.58 | 0.78 | −5.00 | −0.052 |
| 6.99 | 4 | 0.20 | 22.16 | 268.51 | 0.73 | −5.00 | −0.041 |
| 8.87 | 2 | 0.11 | 39.62 | 248.35 | 0.00 | −5.00 | −0.021 |
| 3.94 | 8 | 0.42 | 8.31 | 279.25 | 0.51 | −5.00 | −0.084 |
| 4.2112 | 6 | 0.35 | 10.67 | 280.50 | 0.46 | −5.00 | −0.071 |
| 4.69 | 4 | 0.26 | 19.16 | 279.25 | 0.45 | −5.00 | −0.052 |

Table 2 clearly illustrates that when the rectifier converter station's ESCR varies from 2.83 to 7.96 and the inverter converter station's ESCR varies from 3.93 to 7.96, the inverter current control plant transfer function parameters vary in the following respective ranges:

### ΔI_{di}ε[0.1,0.42] (p.u.)

aε[10.67,41.63] (1/sec)
wε[248.35,280.50] (rad/s)
T_{d}ε[0.06,0.89] (msec)
k_{ci}ε[−0.084,−0.02] (p.u./°)

It will be noted that the module 22 is arranged to determine variations in the listed parameters (above) of the rectifier voltage control transfer function (12) for varying rectifier converter station's effective short circuit ratios. The results of the calculations are illustrated in Table 3.

TABLE 3
Parametric Variations of Rectifier Voltage Control
Plant Transfer Function for Varying ESCRs

| Rectifier | Parameters | | | | |
|---|---|---|---|---|---|
| ESCR | ΔV_{dr} | a | T_{d} | Δαᵣ | kᵥᵣ |
| 8 | −0.042 | 192.68 | 0.34 | 10.00 | −0.0042 |
| 6 | −0.043 | 195.31 | 0.05 | 10.00 | −0.0043 |
| 4 | −0.045 | 192.31 | 0.09 | 10.00 | −0.0045 |
| 2 | −0.046 | 165.29 | 0.16 | 10.00 | −0.0046 |

Table 3 clearly illustrates that when the rectifier converter station's ESCR varies from 2.83 to 7.96, the rectifier voltage control plant transfer function parameters vary in the following ranges:

aε[165.29,195.31] (1/sec)
T_{d}ε[0.05,0.34] (msec)
kᵥᵣε[−0.0046,−0.0042] (p.u./°)

In an example, the module 22 may be arranged to determine variations in the listed parameters for the inverter voltage control plant transfer function (16) for varying inverter converter station's effective short circuit ratios. The results of the calculations are illustrated in Table 4.

TABLE 4
Parametric Variations of Inverter Voltage Control Plant Transfer
Function for Varying ESCRs

| Inverter | Parameters | | | | | |
|---|---|---|---|---|---|---|
| ESCR | ΔV_{di} | a | w | T_{d} | Δαᵢ | kᵥᵢ |
| 8 | −0.074 | 29.95 | 175.18 | 0.78 | −5.00 | 0.0148 |
| 6 | −0.076 | 27.38 | 171.50 | 0.78 | −5.00 | 0.0152 |
| 4 | −0.081 | 25.31 | 165.06 | 0.58 | −5.00 | 0.0162 |

Table 4 clearly illustrates that when the inverter converter station's ESCR varies from varies from 3.93 to 7.96, the following rectifier current control plant transfer function parameters varies in the following respective ranges:

aε[25.31,29.95] (1/sec)
T_{d}ε[0.58,0.78] (msec)
kᵥᵢε[0.015,0.016] (p.u./°)
wε[165.06,175.18] (rad/s).

In any event, as previously mentioned, the design module 22 is arranged to use a QFT design methodology to design the HVDC control system 12. A fundamental element of the QFT design methodology is the generation of parametric uncertainty templates and the integration of these templates into the stability margin design bounds.

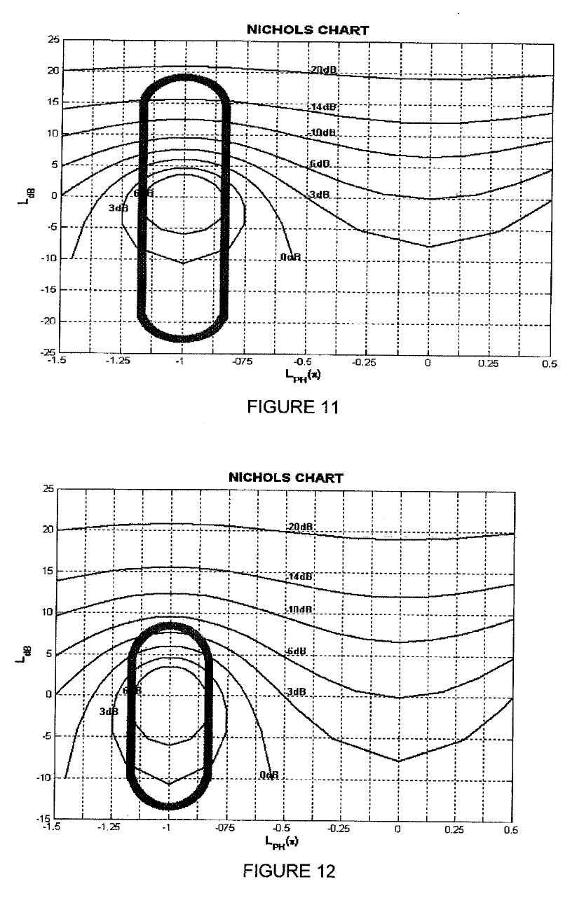

In this regard, FIG. 11 illustrates how the 6 dB stability margin is modified for nominal rectifier current control plant transfer function (4), according to parameter variations illustrated in Table 1.

FIG. 12 illustrates how the 6 dB stability margin is modified for nominal inverter current control plant transfer function (8), according to parameter variations illustrated in Table 2.

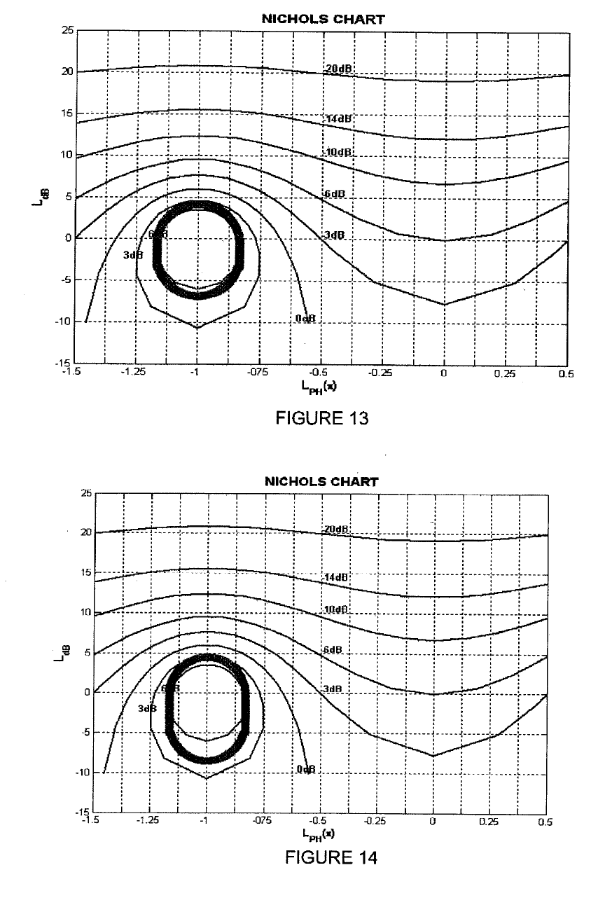

FIG. 13 illustrates how the 6 dB stability margin is modified for nominal rectifier voltage control plant transfer function (12), according to parameter variations illustrated in Table 3.

Similarly, FIG. 14 illustrates how the 6 dB stability margin is modified for nominal inverter voltage control plant transfer function (16), according to parameter variations illustrated in Table 4.

In an example embodiment, the processor 14 is arranged to determine a nominal rectifier current control plant (with the rectifier ESCR=8 and inverter ESCR=8), for example:

$${P}_{cr} ( s ) = - 0.017 \cdot {e}^{- 0.7 \times {10}^{- 3} s} ( \frac{{s}^{3} + 43.85 {s}^{2} + 85.27 s + 1183709}{( s + 14.95 ) ( {s}^{2} + 29.9 s + 84840 )} )$$

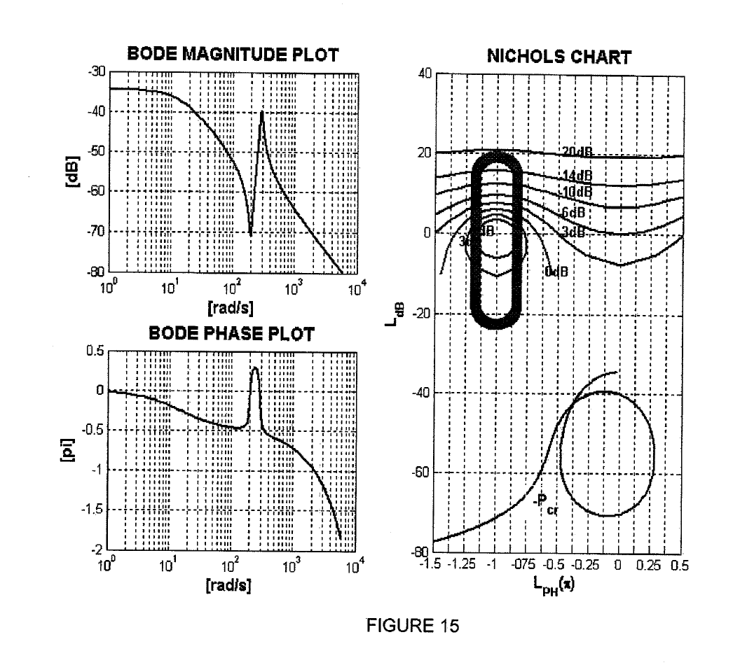

The negative of this plant transfer function is plotted on Nichols Chart with the modified stability margin as shown in FIG. 15.

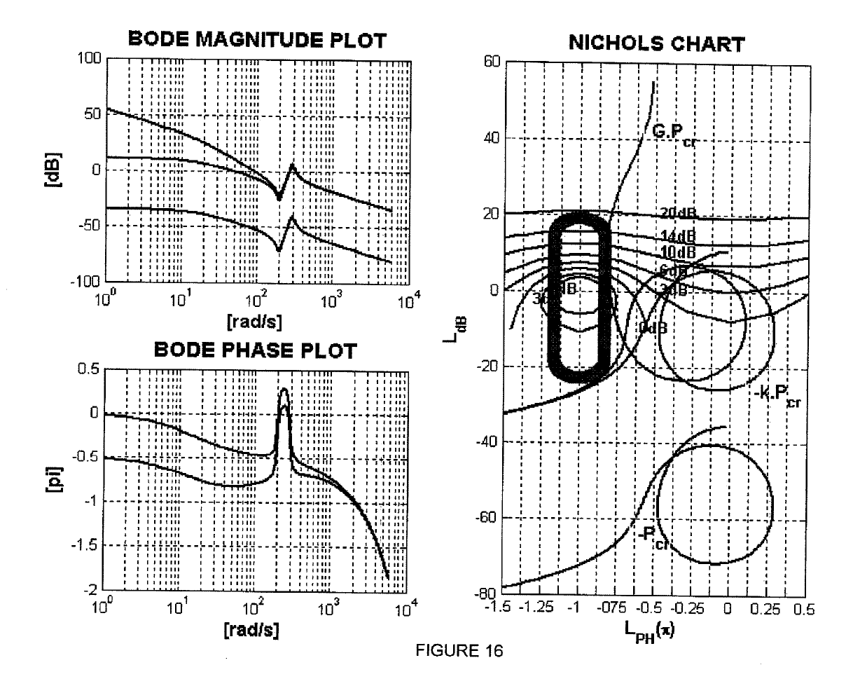

The effect of the designed controller is displayed in FIG. 16, with the plot labelled G·P_{cr}.

To verify the performance of the control system, the following scenario was simulated in using another computer simulation program:
The rectifier's ESCR was equal to 8
The inverter's ESCR was equal to 8
The HVDC system 12 was configured so that the rectifier was in current control mode and the inverter was in voltage control mode.
The inverter's firing angle was held constant at 138 degrees
The rectifier's current controller's parameters were set according to the design.
After the HVDC system 12 is run to steady state, a DC current order was decreased by 5%.

The plant output response to the small signal transient is illustrated in FIG. 17.

The control system performance is evaluated in Table 5, below:

TABLE 5.1
Rectifier Current Controller Performance Assessment

| | | |
|---|---|---|
| Performance Criterion | Expected | Actual |

| | | |
|---|---|---|
| Overshoot | 5% | 2.1% |

| | | | | |
|---|---|---|---|---|
| Settling Time (tₛ) | 24.75 | ms | 23 | ms |

| | | |
|---|---|---|
| Steady state error (□) | <2% | <0.1% |

| | | | | |
|---|---|---|---|---|
| Gain Margin | <6 | dB | <6 | dB |

Table 5 clearly illustrates that the rectifier controller design did meet the specified performance requirements.

The processor 14 is further arranged to determine a nominal rectifier current control plant, with the rectifier ESCR=8 and the inverter ESCR=8, for example:

$${P}_{ci} ( s ) = - 0.053 \cdot {e}^{- 0.06 \times {10}^{- 3} s} ( \frac{{s}^{3} + 44.57 {s}^{2} + 79361 s + 1120034}{( s + 15.19 ) ( {s}^{2} + 30.38 s + 78911 )} )$$

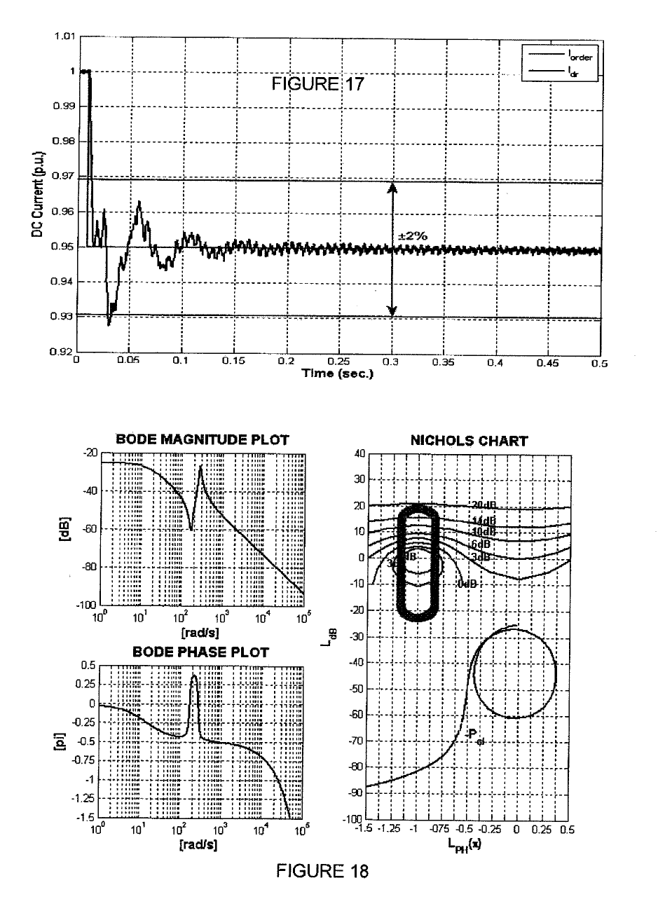

The negative of this plant transfer function is plotted on Nichols Chart with the modified stability margin as shown in FIG. 18.

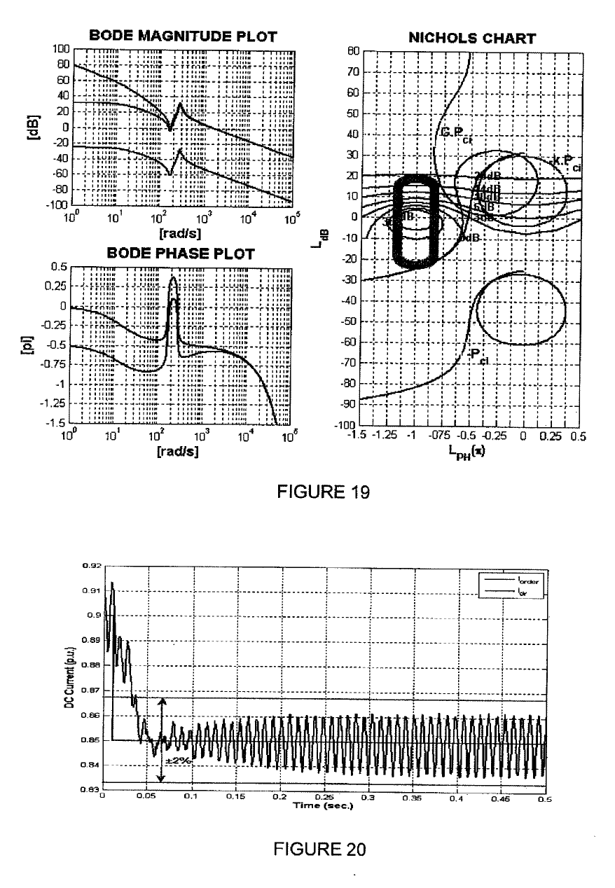

The effect of the designed controller is displayed in FIG. 19, with the plot labelled G·P_{cr}.

To verify the performance of the control system, the following scenario was simulated:
The rectifier's ESCR was equal to 8
The inverter's ESCR was equal to 8
The HVDC system was configured so that the inverter was in current control mode and the rectifier was in voltage control mode.
The rectifier's firing angle was held constant at 27 degrees
The inverter's current controller's parameters were set according to the design.
After the HVDC system 12 is run to steady state, a DC current order was decreased by 5%.

The plant output response to the small signal transient is illustrated in FIG. 20.

The control system performance is evaluated in Table 6, below:

TABLE 5.2
Inverter Current Controller Performance Assessment

| | | |
|---|---|---|
| Performance Criterion | Expected | Actual |

| | | |
|---|---|---|
| Overshoot | 5% | 1.3% |

| | | | | |
|---|---|---|---|---|
| Settling Time (tₛ) | 28.35 | ms | 23 | ms |

| | | |
|---|---|---|
| Steady state error (□) | <2% | <1.3% |

| | | | | |
|---|---|---|---|---|
| Gain Margin | <6 | dB | <6 | dB |

Table 6 clearly illustrates that the rectifier controller design does meet the specified performance requirements.

Till now, the design of the HVDC control system 12 has been sectionalized into separate design and analysis of four controllers that constitute the classic HVDC control system 12. The design and analysis of the complete classic HVDC control system 12 was validated by integrating four controllers as illustrated in FIG. 1.

The stability of the integrated classic HVDC system 12 was verified by simulating the following scenario:
The rectifier's ESCR was equal to 8
The inverter's ESCR was equal to 8
The firing angle of the inverter station is deblock first at tₒ=10 ms.
The rectifier's firing angle is then deblocked at t₁=50 ms and then ramped up
The rectifier's current controller's parameters were set according to the design.
The inverter's current controller's parameters were set according to the design.

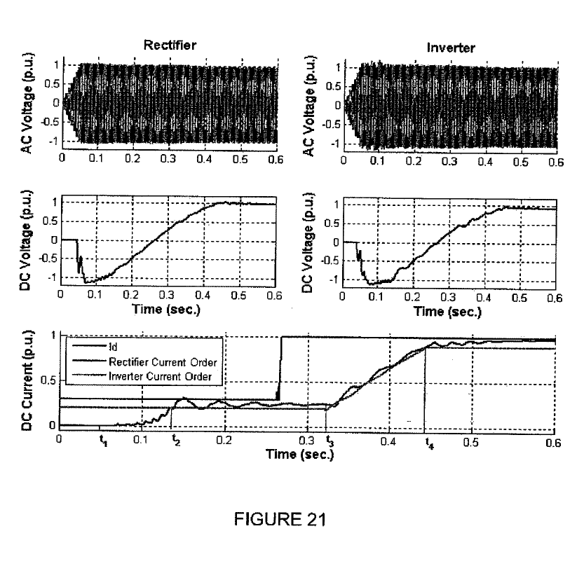

The start-up response of the integrated classic HVDC system is illustrated in FIG. 21. Analysis of start-up response reveals that the DC current increases after t₁. Between time t₃ and t₂, the DC voltage has not increased above the minimum required DC voltage (0.2 p.u.) as specified by the VDCOL, therefore the current order is constrained to the minimum current order (Rectifier −0.3 p.u. and Inverter −0.2 p.u.) as defined by the VDCOL. During this period of time, the designed classic HVDC control system 12 ensures that classic HVDC system operates stably and according to the requirements of the VDCOL.

Between time t₄ and t₃, the dc voltage increases above the minimum required DC voltage and the current order is determined by the inverter VDCOL (Voltage Dependent Current Order Limit). During this period of time, the designed classic HVDC control system ensures that classic HVDC system operates stably and according to the requirements of the inverter VDCOL.

After time t₄, the inverter receives more current than is ordered therefore the current control moves to the rectifier station. During this current control transitional period, the designed classic HVDC control system 12 ensures that the classic HVDC system operates stably and according to the requirements of the rectifier current control amplifier.

It will be noted that after simulating the start-up of a classic HVDC system, the designed classic HVDC control system advantageously ensures a stable start-up process.

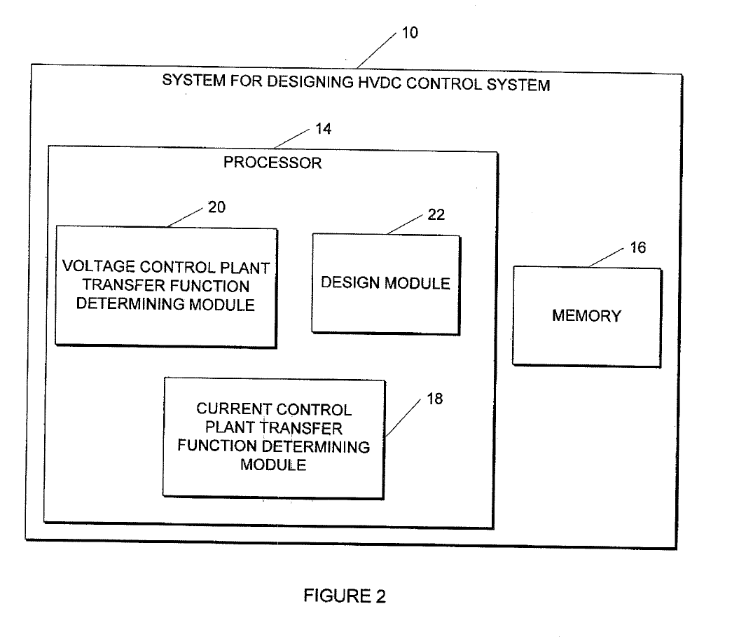

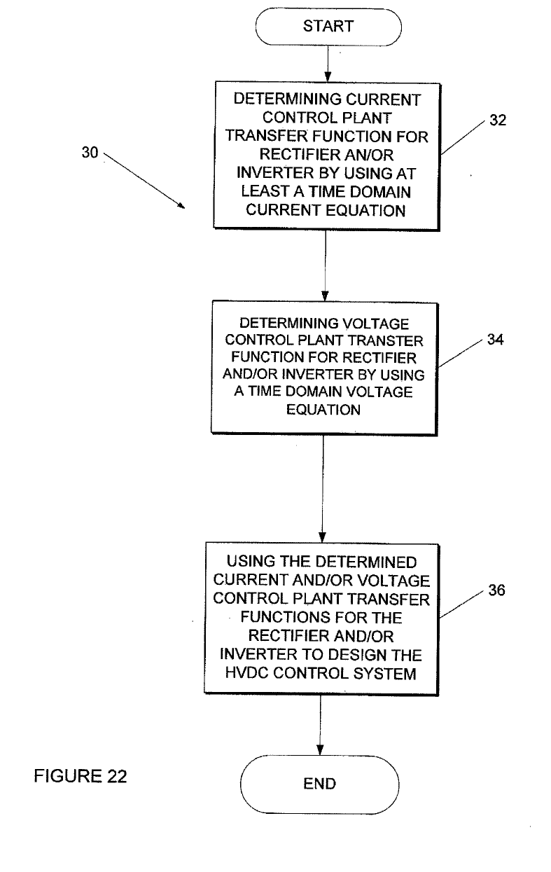

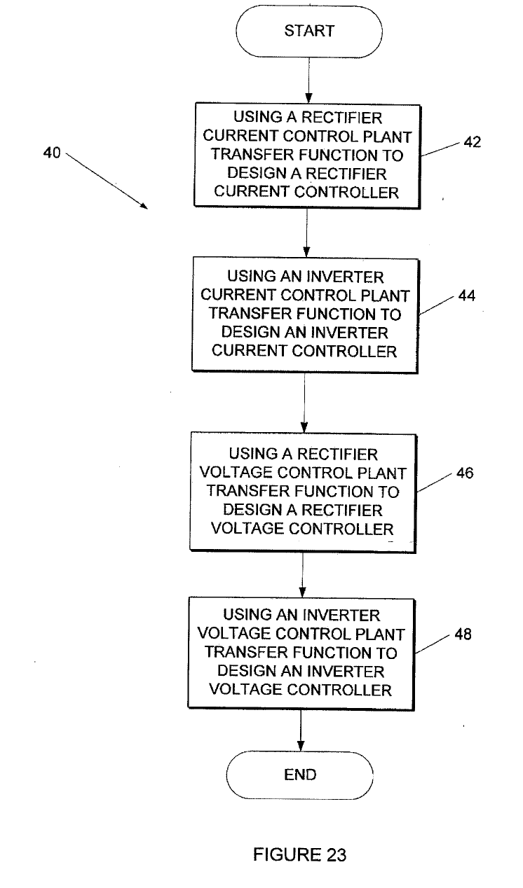

Example embodiments will now be further described in use with reference to FIGS. 22 and 23. The example methods shown in FIGS. 22 and 23 are described with reference to FIGS. 1 and 2, although it is to be appreciated that the example methods may be applicable to other systems (not illustrated) as well.

Referring to FIG. 22 where a flow diagram of a method of facilitating design of a classic High Voltage Direct Current (HVDC) control system, for example the HVDC control system 12, is generally indicated by reference numeral 30.

The method 30 comprises determining, at block 32 by way of module 18, at least a current control plant transfer function for a rectifier and/or inverter of the classic HVDC control system 12 by using at least the time domain current equation (1).

The method 30 further comprises determining, at block 34 by way of the module 20, at least a voltage control plant transfer function for the rectifier and/or inverter of the classic HVDC control system 12 by using time domain voltage equations (9) and (13) respectively as hereinbefore described.

It follows that the method 30 comprises using, at block 36 by way of the module 22, the current control plant transfer function for the rectifier and inverter (1) and (4), and the determined voltage control plant transfer functions for the rectifier and inverter (9) and (13) to facilitate design of the HVDC control system 12 as hereinbefore described.

Referring now to FIG. 23 of the drawings where another flow diagram of a method in accordance with an example embodiment is generally indicated by reference numeral 40.

The method 40 is conveniently carried out by the design module 22 as hereinbefore described. It will be noted that the method 40 is a more simplified methodology to the method 30 in that it merely makes us of the transfer functions which were determined in the method 30.

In any event, the method 40 comprises using, at block 42, the rectifier current control plant transfer function (4) to design a rectifier current controller for the HVDC control system 12 as hereinbefore described.

The method 40 also comprises using, at block 44, the inverter current control plant transfer function (8) to design an inverter current controller for the HVDC control system 12 as hereinbefore described.

The method 40 comprises using, at block 46, the rectifier voltage control plant transfer function (12) to design a rectifier voltage controller for the HVDC control system 12 as hereinbefore described.

The method 40 then comprises using, at block 48, the inverter voltage control plant transfer function (16) to design an inverter voltage controller for the HVDC control system 12 as hereinbefore described.

It will be noted that the invention as hereinbefore described may also be used to optimize an HVDC control system. In this regard, an HVDC control system may be retrospectively designed in accordance with the invention.

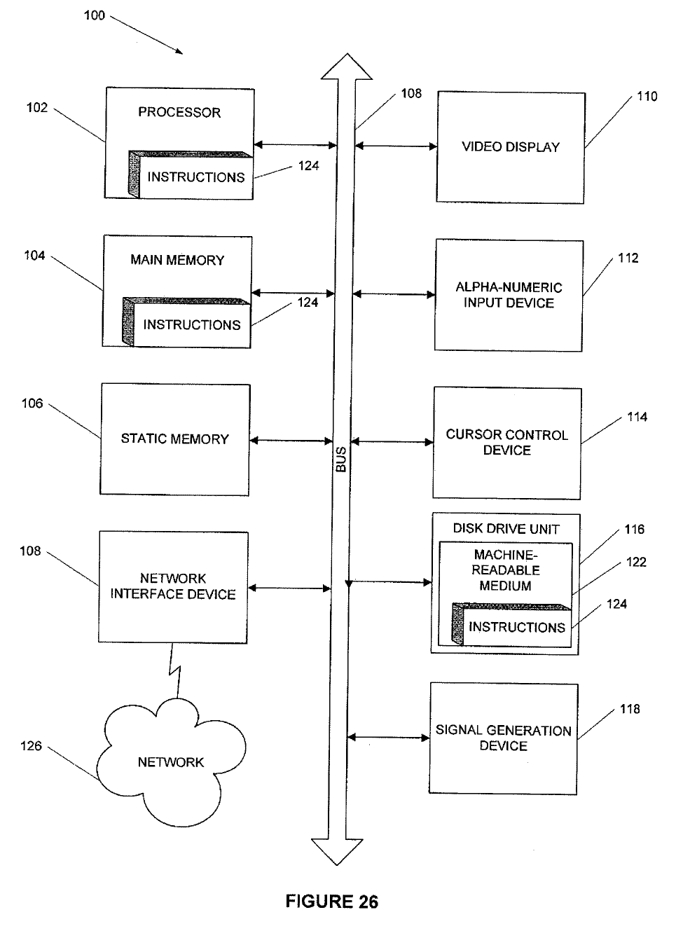

FIG. 26 shows a diagrammatic representation of machine in the example form of a computer system 100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions and data structures (e.g., software 124) embodying or utilized by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilizing any one of a number of well-known transfer protocols (e.g., HTTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The invention as hereinbefore described provides a convenient way to determine the plant transfer functions for any classic HVDC system. These plant transfer functions can be used to design classic HVDC control systems using standard frequency domain design methodologies. The invention may significantly reduce classic HVDC control system design man-hours. The previous methods involved trial and error techniques to design classic HVDC control systems. The classic HVDC control systems designed using these techniques were labour intensive and not necessarily robust.

Expert knowledge is usually required to use the trial and error techniques and due to a HVDC skills shortage, the invention will assist relatively inexperienced engineers to design classic HVDC schemes.

It follows that with the present invention, classic HVDC control systems can be designed much faster and have a more robust performance.

1. A method of determining one or more plant transfer functions for use in the design of a line-current commutated High Voltage Direct Current (HVDC) control system, the method comprising one or both of the steps of:
determining a current control plant transfer function for one or both of a rectifier and inverter of the line-current commutated HVDC control system by using a time domain current equation; and
determining a voltage control plant transfer function for one or both of a rectifier and inverter of the line-commutated HVDC control system by using a time domain voltage equation.

2. A method as claimed in claim 1, wherein the time domain current equation is a first time domain current equation:
$${I}_{d} ( t ) = \{ \begin{matrix}1 \cdot 1 \cdot m ( Δ {I}_{d} - {I}_{d 1} ) \cdot ( 1 - {e}^{- bt} ) \\ \begin{matrix}1 \cdot 1 \cdot m \cdot ( Δ {I}_{d} - {I}_{d 1} ) ( 1 - {e}^{- b \cdot t} ) + & 0 < t < {T}_{o} \\ {I}_{d 1} \cdot ( n - p \cdot k \cdot {e}^{- a \cdot t} + c \cdot k \cdot {e}^{- a \cdot t} \cdot ( sin ( wt ) - m \cdot cos ( wt ) ) & t \geq {T}_{o}\end{matrix}\end{matrix}$$
wherein:
I_{d1} is a first peak of an oscillating component of a dc current associated with the HVDC control system;
ΔI_{d} is a final value of the dc current from a nominalised zero reference;
$$a = \frac{r}{{T}_{1}} ,$$
wherein:
T₁ is a time associated with a first peak of the dc current; and
r is a constant;
$$w = \frac{2 π}{{T}_{2}} ,$$
wherein:
T₂ is a first period of the oscillating component of the dc current;
k is a constant;
T_{∞} is a time which the HVDC control system takes to reach a final value;
$$b = \frac{log ( \frac{1}{11} ) - log ( 1 - \frac{10 \cdot {I}_{d 1} ( 1 - {e}^{- 1} )}{11 \cdot Δ {I}_{d}} )}{- {T}_{∞}} ;$$
and
Tₒ is a time delay selected at least to avoid formation of very high order models.

3. (canceled)

4. (canceled)

5. A method as claimed in claim 1, wherein the time domain current equation is a second time domain current equation used for HVDC control systems where a rectifier effective short circuit ration is greater than approximately 2.6, wherein the second time domain current equation is:
$$Δ {I}_{d} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d}\end{matrix} ; ,$$
wherein:
T_{d} is a time delay associated with time taken for an input to the system to effect an output of the HVDC control system;
ΔI_{d} is a change in dc current associated with the HVDC control system from an initial operating point or position;
$$a = \frac{1}{{T}_{1}} ;$$
wherein T₁ is the time it takes a decaying waveform associated with the HVDC control system to reach e⁻¹ of its final value.
$$w = \frac{2 π}{{T}_{2}} ;$$
wherein T₂ is the period of a superimposed ac waveform; and
k is a constant.

6. (canceled)

7. (canceled)

8. A method according to claim 1, wherein the time domain voltage equation is a first time domain voltage equation:
$$Δ {V}_{d} ( t ) = \{ \begin{matrix}0 & t < {T}_{d} \\ Δ {V}_{d} ( 1 - {e}^{- at} ) & t \geq {T}_{d} ;\end{matrix} and ,$$
wherein
T_{d} is a time delay associated with time taken for an input to the HVDC control system to effect an output of the HVDC control system;
ΔV_{d} is a change in dc voltage in the HVDC control system; and
$$a = \frac{1}{{T}_{1}} ,$$
wherein:
T₁ is the time it takes a decaying waveform associated with the HVDC control system to reach e⁻¹ of its final value.

9. A method as claimed in claim 1, wherein the time domain voltage equation is a second time domain voltage equation used for determining the voltage control plant transfer function for the inverter of the line-current commutated HVDC control system, wherein the second time domain voltage equation is:
$$Δ {V}_{d} ( t ) = \{ \begin{matrix}0 & t < {T}_{d} \\ Δ {V}_{d} \cdot ( 1 - {e}^{- at} \cdot cos ( wt ) ) & t \geq {T}_{d} ,\end{matrix}$$
wherein:
T_{d} is a time delay associated with time taken for an input to the HVDC control system to effect an output of the HVDC control system;
ΔV_{d} is a change in dc voltage of the HVDC control system;
$$a = \frac{1}{{T}_{1}} ,$$
wherein T₁ is the time it takes a decaying waveform associated with the HVDC control system to reach e⁻¹ of its final value; and
$$w = \frac{2 π}{{T}_{2}} ,$$
wherein T₂ is the period of a superimposed ac waveform.

10. (canceled)

11. A method as claimed in claim 1, wherein the method comprises:
determining a Laplace transform of the time domain current equation;
determining a Laplace transform of one or both of an inverter and rectifier firing angle of the HVDC control system; and
determining one or both of the inverter current control plant transfer function of the HVDC control system, wherein determining the inverter current control plant transfer function comprises determining a ratio of the determined Laplace transform of the time domain current equation and the determined Laplace transform of the inverter firing angle; and wherein determining the rectifier current control plant transfer function comprises determining a ratio of the determined Laplace transform of the time domain current equation and the determined Laplace transform of the rectifier firing angle.

12. (canceled)

13. (canceled)

14. (canceled)

15. (canceled)

16. (canceled)

17. A method as claimed in claim 1, further comprising:
determining a Laplace transform of the time domain voltage equation;
determining a Laplace transform of one or both of an inverter and rectifier firing angle of the HVDC control system; and
determining a one or both of the inverter and rectifier voltage control plant transfer function of the HVDC control system, wherein determining the inverter voltage control plant transfer function comprises determining a ratio of the determined Laplace transform of the time domain voltage equation and the determined Laplace transform of the inverter firing angle; and wherein determining the rectifier voltage control plant transfer function comprises determining a ratio of the determined Laplace transform of the time domain voltage equation and the determined Laplace transform of the rectifier firing angle.

18. A method for designing or facilitating design of a rectifier voltage controller for a line-current commutated High Voltage Direct Current (HVDC) control system, the method comprising using a rectifier control plant transfer function to design or facilitate design of the rectifier voltage controller, wherein the rectifier voltage control plant transfer function:
$${P}_{v} ( s ) = \frac{Δ {V}_{d}}{Δα} \frac{1}{s + a} {e}^{- {T}_{d} \cdot s} ,$$
wherein:
T_{d} is a time delay associated with time taken for an input to the HVDC control system to effect an output of the HVDC control system;
$$a = \frac{1}{{T}_{1}} ,$$
wherein T₁ is a time it takes the decaying waveform associated with the HVDC control system to reach e⁻¹ of its final value; and
$${k}_{v} = \frac{Δ {V}_{d}}{Δα}$$
is a gain of the rectifier voltage control plant transfer function

19. (canceled)

20. (canceled)

21. A method for designing or facilitating design of an inverter voltage controller for a line-current commutated High Voltage Direct Current (HVDC) control system, the method comprising using an inverter voltage control plant transfer function to design or facilitate design of the inverter voltage controller, wherein the inverter voltage control plant transfer function is given by the equation:
$${P}_{v} ( s ) = \frac{Δ {V}_{d}}{Δα} \frac{w}{{( s + a )}^{2} + {w}^{2}} {e}^{- {T}_{d} \cdot s} . ,$$
wherein:
T_{d} is a time delay associated with time taken for an input to the HVDC control system to effect an output of the HVDC control system;
ΔV_{d} is a change in DC voltage of the HVDC control system;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of the superimposed ac waveform; and
$${k}_{v} = \frac{Δ {V}_{d}}{Δα}$$
is the gain of the inverter voltage control plant transfer function.

22. (canceled)

23. (canceled)

24. A system for determining one or more plant transfer functions for use in the design of a line-current commutated High Voltage Direct Current (HVDC) control system, the system comprising:
a memory for storing data;
a processor operatively connected to the memory, the processor including one or both of:
a current control plant transfer function determining module configured to determine at least a current control plant transfer function for one or both of a rectifier and inverter of the classic HVDC control system by using a time domain current equation; and
a voltage control plant transfer function determining module configured to determine at least a voltage control plant transfer function for one or both of a rectifier and inverter of the classic HVDC control system by using a time domain voltage equation.

25. A system as claimed in claim 24, wherein the current control plant transfer function determining module is configured to use a first time domain current equation to determine one or both of the current control plant transfer function for the rectifier and inverter, wherein the first time domain current equation is:
$${I}_{dr} ( t ) = \{ \begin{matrix}1 \cdot 1 \cdot m \cdot ( Δ {I}_{d} - {I}_{d 1} ) \cdot ( 1 - {e}^{- bt} ) & 0 < t < {T}_{o} \\ \begin{matrix}1 \cdot 1 \cdot m \cdot ( Δ {I}_{d} - {I}_{d 1} ) ( 1 - {e}^{- b \cdot t} ) + \\ {I}_{d 1} \cdot ( n - p \cdot k \cdot {e}^{- a \cdot t} + c \cdot k \cdot {e}^{- a \cdot t} \cdot \\ ( sin ( wt ) - m \cdot cos ( wt ) ) ,\end{matrix} & t \geq {T}_{o}\end{matrix}$$
wherein:
I_{d1} is a first peak of an oscillating component of a dc current associated with the HVDC control system;
ΔI_{d} is a final value of the dc current from a nominalised zero reference;
$$a = \frac{r}{{T}_{1}} ,$$
wherein:
T₁ is a time associated with a first peak of the dc current; and
r is a constant:
$$w = \frac{2 π}{{T}_{2}} ,$$
wherein:
T₂ is a first period of the oscillating component of the dc current;
k is a constant;
T_{∞} is a time which the HVDC control system takes to reach a final value;
$$b = \frac{log ( \frac{1}{11} ) - log ( 1 - \frac{10 \cdot {I}_{d 1} ( 1 - {e}^{- 1} )}{11 \cdot Δ {I}_{d}} )}{- {T}_{∞}} ;$$
and
Tₒ is a time delay selected at least to avoid formation of very high order models.

26. A system as claimed in claim 24, wherein the current control plant transfer function determining module is configured to use a second time domain current equation to determine the current control plant transfer function for one or both of the inverter and the rectifier where a rectifier effective short circuit ratio is greater than approximately 2.6, wherein the second time domain current equation is:
$$Δ {I}_{d} ( t ) = \{ \begin{matrix}0 & t < {T}_{d} \\ Δ {I}_{d} ( 1 - {e}^{- at} + k \vert Δ {I}_{d} \vert \cdot {e}^{- at} \cdot sin ( wt ) ) & t \geq {T}_{d} ;\end{matrix} ,$$
wherein:
T_{d} is a time delay associated with time taken for an input to the system to effect an output of the HVDC control system;
ΔI_{d} is a change in dc current associated with the HVDC control system from an initial operating point or position;
$$a = \frac{1}{{T}_{1}} ;$$
wherein T₁ is the time it takes a decaying waveform associated with the HVDC control system to reach e⁻¹ of its final value.
$$w = \frac{2 π}{{T}_{2}} ;$$
wherein T₂ is the period of a superimposed ac waveform; and
k is a constant.

27. A system as claimed in claim 24, wherein the voltage control plant transfer function determining module is configured to use a first time domain voltage equation to determine the voltage control plant transfer function for the rectifier, wherein the first time domain voltage equation is:
$$Δ {V}_{d} ( t ) = \{ \begin{matrix}0 & t < {T}_{d} \\ Δ {V}_{d} ( 1 - {e}^{- at} ) & t \geq {T}_{d} ;\end{matrix} and ,$$
wherein
T_{d} is a time delay associated with time taken for an input to the HVDC control system to effect an output of the HVDC control system;
ΔV_{d} is a change in dc voltage in the HVDC control system; and
$$a = \frac{1}{{T}_{1}} ,$$
wherein:
T₁ is the time it takes a decaying waveform associated with the HVDC control system to reach e⁻¹ of its final value.

28. A system as claimed in claim 24, wherein the voltage control plant transfer function determining module is configured to use a second time domain voltage equation to determine the voltage control plant transfer function for the inverter, wherein the second time domain voltage equation is:
$$Δ {V}_{d} ( t ) = \{ \begin{matrix}0 & t < {T}_{d} \\ Δ {V}_{d} \cdot ( 1 - {e}^{- at} \cdot cos ( wt ) ) & t \geq {T}_{d} ,\end{matrix}$$
wherein:
T_{d} is a time delay associated with time taken for an input to the HVDC control system to effect an output of the HVDC control system;
ΔV_{d} is a change in dc voltage of the HVDC control system;
$$a = \frac{1}{{T}_{1}} ,$$
wherein T₁ is the time it takes a decaying waveform associated with the HVDC control system to reach e⁻¹ of its final value; and
$$w = \frac{2 π}{{T}_{2}} ,$$
wherein T₂ is the period of a superimposed ac waveform.

29. A system as claimed in claim 24, wherein the current control plant transfer function determining module is configured to:
determine a Laplace transform of the time domain current equation;
determine a Laplace transform of one or both of an inverter and a rectifier firing angle of the HVDC control system; and
determine one or both of the inverter current control plant transfer function of the HVDC control system, wherein the current control plant transfer function determining module is configured to determining the inverter current control plant transfer function by determining a ratio of the determined Laplace transform of the time domain current equation and the determined Laplace transform of the inverter firing angle; and configured to determine the rectifier current control plant transfer function by determining a ratio of the determined Laplace transform of the time domain current equation and the determined Laplace transform of the rectifier firing angle.

30. (canceled)

31. (canceled)

32. (canceled)

33. A system as claimed in claim 24, wherein the voltage control plant transfer function determining module is configured to:
determine a Laplace transform of the time domain voltage equation;
determine a Laplace transform of one or both of an inverter and the rectifier firing angle of the HVDC control system; and
determine a one or both of the inverter and rectifier voltage control plant transfer function of the HVDC control system, wherein the voltage control plant transfer function determining module is configured to determine the inverter voltage control plant transfer function by determining a ratio of the determined Laplace transform of the time domain voltage equation and the determined Laplace transform of the inverter firing angle; and further configured to determine the rectifier voltage control plant transfer function by determining a ratio of the determined Laplace transform of the time domain voltage equation and the determined Laplace transform of the rectifier firing angle.

34. (canceled)

35. (canceled)

36. (canceled)

37. (canceled)

38. A method of facilitating design of a line-current commutated High Voltage Direct Current (HVDC) control system, the method comprising:
using a rectifier current control plant transfer function:
$${P}_{cr} ( s ) = \frac{Δ {I}_{dr}}{Δ {α}_{r}} \cdot {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$
wherein:
key output parametric variables are:
T_{d} is a time delay associated with time taken for an input to the HVDC control system to effect an output of the HVDC control system;
ΔI_{d} is a change in the dc current;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of a superimposed ac waveform;
Δαᵣ is a change in the rectifier firing angle; and
$${k}_{cr} = \frac{Δ {I}_{dr}}{Δ {α}_{r}}$$
is a gain of the rectifier control plant transfer function, to design a rectifier current controller for the HVDC control system;
using an inverter current control plant transfer function:
$$Δ {P}_{ci} ( s ) = \frac{Δ {I}_{di}}{Δ {α}_{i}} \cdot {e}^{- {T}_{d} s} ( \frac{\begin{matrix}{s}^{3} + ( 3 a - 1 ) {s}^{2} + \\ ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$
wherein:
T_{d} is a time delay associated with time taken for an input to the HVDC control system to effect an output of the HVDC control system;
ΔI_{di} is a change in the dc current;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of a superimposed ac waveform;
Δαᵢ is a change in the inverter firing angle; and
$${k}_{ci} = \frac{Δ {I}_{di}}{Δ {α}_{i}}$$
is a gain of the inverter control plant transfer function,
to design an inverter current controller for the HVDC control system;
using a rectifier voltage control plant transfer function:
$${P}_{vr} ( s ) = \frac{Δ {V}_{dr}}{{Δα}_{r}} \frac{1}{s + a} {e}^{- {T}_{d} \cdot s} ,$$
wherein:
T_{d} is a time delay associated with time taken for an input to the HVDC control system to effect an output of the HVDC control system;
$$a = \frac{1}{{T}_{1}} ,$$
wherein T₁ is a time it takes the decaying waveform associated with the HVDC control system to reach e⁻¹ of its final value; and
$${k}_{vr} = \frac{Δ {V}_{dr}}{Δ {α}_{r}}$$
is a gain of the rectifier voltage control plant transfer function to design a rectifier voltage controller for the HVDC control system; and
using an inverter voltage control plant transfer function:
$${P}_{vi} ( s ) = \frac{Δ {V}_{di}}{{Δα}_{i}} \frac{w}{{( s + a )}^{2} + {w}^{2}} {e}^{- {T}_{d} \cdot s} ,$$
wherein:
T_{d} is a time delay associated with time taken for an input to the HVDC control system to effect an output of the HVDC control system;
ΔV_{di} is a change in DC voltage of the HVDC control system;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of the superimposed ac waveform; and
$${k}_{vi} = \frac{Δ {V}_{di}}{Δ {α}_{i}}$$
is the gain of the inverter voltage control plant transfer function, to design an inverter voltage controller for the HVDC control system.

39. A system for facilitating design of a line-current commutated High Voltage Direct Current (HVDC) control system, the system comprising:
a memory for storing data;
a processor operatively connected to the memory, the processor including:
a design module arranged to:
use a rectifier current control plant transfer function:
$${P}_{cr} ( s ) = \frac{Δ {I}_{dr}}{Δ {α}_{r}} \cdot {e}^{- {T}_{d} s} ( \frac{\begin{matrix}{s}^{3} + ( 3 a - 1 ) {s}^{2} + \\ ( 3 {a}^{2} - 2 a + {w}^{2} + k \vert Δ {I}_{dr} \vert w ) s + \\ ( {a}^{3} - {a}^{2} + {aw}^{2} - {w}^{2} + k \vert Δ {I}_{dr} \vert aw )\end{matrix}}{( s + a ) ( {s}^{2} + 2 as + {a}^{2} + {w}^{2} )} ) ,$$
wherein:
key output parametric variables are:
T_{d} is a time delay associated with time taken for an input to the HVDC control system to effect an output of the HVDC control system;
ΔI_{d} is a change in the dc current;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of a superimposed ac waveform;
Δαᵣ is a change in the rectifier firing angle; and
$${k}_{cr} = \frac{Δ {I}_{dr}}{Δ {α}_{r}}$$
is a gain of the rectifier control plant transfer function, to design a rectifier current controller for the HVDC control system;
use an inverter current control plant transfer function:
$$Δ {P}_{ci} ( s ) = \frac{Δ {I}_{di}}{Δ {α}_{i}} . {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{di} \vert w ) s + \\ ( {a}^{3} - {a}^{2} + {aw}^{2} - {w}^{2} + k \vert Δ {I}_{di} \vert aw )\end{matrix}}{( s + a ) ( {s}^{2} + 2 as + {a}^{2} + {w}^{2} )} ) ,$$
wherein:
T_{d} is a time delay associated with time taken for an input to the HVDC control system to effect an output of the HVDC control system;
ΔI_{d}_{ᵢ} is a change in the dc current;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of a superimposed ac waveform;
Δαᵢ is a change in the inverter firing angle; and
$${k}_{cl} = \frac{Δ {I}_{di}}{Δ {α}_{i}}$$
is a gain of the inverter control plant transfer function,
to design an inverter current controller for the HVDC control system;
use a rectifier voltage control plant transfer function:
$${P}_{vr} ( s ) = \frac{Δ {V}_{dr}}{Δ {α}_{r}} \frac{1}{s + a} {e}^{- {T}_{d} . s} ,$$
wherein:
T_{d} is a time delay associated with time taken for an input to the HVDC control system to effect an output of the HVDC control system;
$$a = \frac{1}{{T}_{1}} ,$$
wherein T₁ is a time it takes the decaying waveform associated with the HVDC control system to reach e⁻¹ of its final value; and
$${k}_{vr} = \frac{Δ {V}_{dr}}{Δ {α}_{r}}$$
is a gain of the rectifier voltage control plant transfer function to design a rectifier voltage controller for the HVDC control system; and
using an inverter voltage control plant transfer function:
$${P}_{vi} ( s ) = \frac{Δ {V}_{di}}{{Δα}_{i}} \frac{w}{{( s + a )}^{2} + {w}^{2}} {e}^{- {T}_{d} . s} ,$$
wherein:
T_{d} is a time delay associated with time taken for an input to the HVDC control system to effect an output of the HVDC control system;
ΔV_{di} is a change in DC voltage of the HVDC control system;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of the superimposed ac waveform; and
$${k}_{vi} = \frac{Δ {V}_{di}}{{Δα}_{i}}$$
is the gain of the inverter voltage control plant transfer function,
to design an inverter voltage controller for the HVDC control system.

40. (canceled)

41. (canceled)

42. (canceled)

43. (canceled)

44. (canceled)

45. An HVDC control system designed using the method of claim 1, or the system as claimed in claim 11.

46. (canceled)

47. (canceled)

48. A method for designing or facilitating design of one or both of an inverter or rectifier current controller for a line-current commutated High Voltage Direct Current (HVDC) control system, the method comprising using a current control plant transfer function to design one or both of the inverter and rectifier current controller, wherein the current control plant transfer function is:
$${P}_{c} ( s ) = \frac{Δ {I}_{d}}{Δ α} . {e}^{- {T}_{d} s} ( \frac{\begin{matrix}{s}^{3} + ( 3 a - 1 ) {s}^{2} + ( 3 {a}^{2} - 2 a + {w}^{2} + k \vert Δ {I}_{d} \vert w ) s + \\ ( {a}^{3} - {a}^{2} + {aw}^{2} - {w}^{2} + k \vert Δ {I}_{d} \vert aw )\end{matrix}}{( s + a ) ( {s}^{2} + 2 as + {a}^{2} + {w}^{2} )} ) ,$$
wherein:
T_{d} is a time delay associated with time taken for an input to the HVDC control system to effect an output of the HVDC control system;
ΔI_{d} is a change in the dc current;
$$a = \frac{1}{{T}_{1}} ,$$
wherein T₁ is the time it takes the decaying waveform associated with the HVDC control system to reach e⁻¹ of its final value;
$$w = \frac{2 π}{{T}_{2}} ,$$
wherein T₂ is the period of a superimposed ac waveform;
Δα is a change in the inverter or rectifier firing angle; and
$${k}_{c} = \frac{Δ {I}_{d}}{Δα}$$
is a gain of the inverter or rectifier control plant transfer function.

49. An HVDC control system designed using the system of claim 24.
